(19) United States
(12) Patent Application Publication
(10) Pub. No.: US 2025/0065272 A1
(43) Pub. Date: Feb. 27, 2025

(54) METHOD FOR OPERATING SEPARATION MEMBRANE, SEPARATION MEMBRANE DEVICE, AND PROGRAM FOR DETERMINING OPERATING CONDITIONS OF SEPARATION MEMBRANE

(71) Applicant: Toray Industries, Inc., Chuo-ku, Tokyo (JP)

(72) Inventors: Hiroshi HAMADA, Otsu-shi, Shiga (JP); Kazuki HAGAWA, Otsu-shi, Shiga (JP); Takumi KOBAYASHI, Otsu-shi, Shiga (JP)

(73) Assignee: Toray Industries, Inc., Chuo-ku, Tokyo (JP)

(21) Appl. No.: 18/724,298

(22) PCT Filed: Dec. 26, 2022
(86) PCT No.: PCT/JP2022/047974

§ 371 Date: Jun. 26, 2024

(30) Foreign Application Priority Data
Dec. 27, 2021 (JP) 2021-212050

(51) Int. Cl. B01D 65/02; B01D 61/14; C02F 1/44; C02F 3/12

(52) U.S. Cl. CPC B01D 65/02; B01D 61/145; B01D 61/147; C02F 1/444; C02F 3/1268; B01D 2321/162; B01D 2321/30; B01D 2321/40; C02F 2209/006; C02F 2209/03; C02F 2209/44; C02F 2303/16

(57) ABSTRACT

The present invention relates to a method for operating a separation membrane in which a liquid-to-be-filtrated is subjected to filtration to obtain a filtrate, the method including: an accumulated amount calculation step of calculating an amount of constituent components of the liquid-to-be-filtrated accumulated on a surface and in pores of the separation membrane after setting an initial value; a chemical liquid cleaning effect calculation step of calculating a restoration degree of an accumulated amount of the constituent components or membrane filtration resistance in chemical liquid cleaning based on a result of accumulated amount calculation; and a chemical liquid cleaning condition determination step of determining a chemical liquid cleaning condition based on results obtained in the accumulated amount calculation step and the chemical liquid cleaning effect calculation step.

### CROSS REFERENCE TO RELATED APPLICATIONS

This application is the U.S. National Phase of PCT/JP2022/047974, filed Dec. 26, 2022 which claims priority to Japanese Patent Application No. 2021-212050 filed Dec. 27, 2021, the disclosures of these applications being incorporated herein by reference in their entireties for all purposes.

### FIELD OF THE INVENTION

The present invention relates to a method for operating a separation membrane, a separation membrane device, and a program for determining operating conditions of a separation membrane for treating natural water such as river water, lake water, and seawater, wastewater, and industrial wastewater using a separation membrane.

### BACKGROUND OF THE INVENTION

Since a membrane separation method has advantages such as energy and space saving, and improvement in quality of filtrate, the membrane separation method is widely used in various fields. Examples of the membrane separation method include application to a water purification process of producing industrial water or tap water from river water, ground water, or sewage treatment water using a microfiltration membrane or an ultrafiltration membrane, application to a production process in the field of food industry, and application to a seawater desalination process using a reverse osmosis membrane or a nanofiltration membrane.

For example, a membrane separation activated sludge method used for treating sewage or industrial wastewater is a treatment method in which activated sludge is subject to biological treatment in a biological reaction tank, and the activated sludge is separated into solid and liquid using a filtration membrane or the like immersed in the reaction tank to obtain clear treated water. In such a membrane separation activated sludge method, since solid substances such as impurities in the activated sludge or a liquid to be treated that flows into the reaction tank adhere on a surface of a separation membrane, and transmembrane pressure difference increases (fouling occurs) due to the adhered substances, physical cleaning such as reverse pressure cleaning (reverse cleaning) of pressure-pushing filtrate or clear water in a direction opposite to that in a separation membrane filtration method to remove contaminants adhered on the surface of the separation membrane or in pores of the membrane, and air cleaning of diffusing air or the like by an air diffuser installed below a filtration membrane to prevent adhesion of deposits on the surface of the separation membrane by air bubbles and an upward air flow is performed. Although filtration is performed while physically cleaning the surface of the membrane in this manner, it is difficult to sufficiently prevent the progress of clogging of the membrane for a long period of time under continuous operations. Therefore, at a timing when the transmembrane pressure difference (or membrane filtration resistance) increases, at a timing after a membrane module is operated for a certain period of time, or the like, the membrane is chemically cleaned using a chemical liquid to perform an operation of restoring water permeability of the membrane, that is, chemical liquid cleaning. Here, from the viewpoint of more reliably removing accumulated fouling, it is preferable to use a high-concentration cleaning liquid and increase a chemical liquid cleaning time. However, when the high-concentration cleaning liquid is used or when the chemical liquid cleaning time is long, a chemical liquid cost may be increased due to excessive cleaning or deterioration of a membrane may progress. Accordingly, in the chemical liquid cleaning, it is required to determine a cleaning condition without excess or deficiency according to an accumulated fouling amount.

A technique disclosed in Patent Literature 1 is known in relation to such a technique. Patent Literature 1 discloses that a cleaning intensity at the time of performing subsequent chemical liquid cleaning is determined based on a transmembrane pressure difference value or a membrane filtration resistance value of a filtration membrane immediately after chemical liquid cleaning of the filtration membrane.

### PATENT LITERATURE

Patent Literature 1: JP2017-18859A

### SUMMARY OF THE INVENTION

However, in the technique disclosed in Patent Literature 1, although an appropriate chemical liquid cleaning condition can be determined in each chemical liquid cleaning as long as a state at the time of each chemical liquid cleaning is always the same, a fouling state of a surface of a membrane changes from moment to moment depending on operating conditions and properties of a liquid-to-be-filtrated, and thus it is not sufficient to determine a chemical liquid cleaning condition according to the fouling state.

Here, an object of the present disclosure is to provide an effective method for operating a separation membrane by predicting a fouling state of the separation membrane at the time of chemical liquid cleaning and determining an appropriate chemical liquid cleaning condition according to the fouling state.

In order to achieve the above object, the present disclosure has the following configurations.

1. A method for operating a separation membrane in which a liquid-to-be-filtrated is subjected to filtration to obtain a filtrate, the method including:
an accumulated amount calculation step of, based on an initial value of an amount of constituent components of a liquid-to-be-filtrated accumulated in a separation membrane, and
a change over time in the constituent components of the liquid-to-be-filtrated, a change over time in the amount of the constituent components, and a change over time in an operating condition of the separation membrane after setting the initial value,
calculating the amount of the constituent components of the liquid-to-be-filtrated accumulated on a surface and in pores of the separation membrane after setting the initial value;
a chemical liquid cleaning effect calculation step of calculating a restoration degree of an accumulated amount of the constituent components or membrane filtration resistance in chemical liquid cleaning based on a result of accumulated amount calculation; and
a chemical liquid cleaning condition determination step of determining a chemical liquid cleaning condition based on results obtained in the accumulated amount calculation step and the chemical liquid cleaning effect calculation step.

2. The method for operating a separation membrane according to 1, in which
the separation membrane is a microfiltration membrane or an ultrafiltration membrane.

3. The method for operating a separation membrane according to 1 or 2, in which
the liquid-to-be-filtrated is an activated sludge or a microorganism culture solution.

4. The method for operating a separation membrane according to any one of 1 to 3, in which
the method for operating a separation membrane is an operation method of cleaning the surface of the separation membrane simultaneously or intermittently with filtration.

5 The method for operating a separation membrane according to any one of 1 to 4, in which
the membrane filtration resistance or the amount of the constituent components of the liquid-to-be-filtrated accumulated on the surface of the separation membrane, which is calculated in the accumulated amount calculation step, is divided into a plurality of pieces of membrane filtration resistance or amounts of the constituent components of the liquid-to-be-filtrated based on a physical cleaning condition for peeling or a degree of consolidation.

6. The chemical liquid cleaning method for a separation membrane according to any one of 1 to 5, in which
the method for operating a separation membrane is an operation method for continuing membrane filtration while controlling a membrane filtration flow rate (flux) to a set value, and in the accumulated amount calculation step, the membrane filtration resistance or the amount of the constituent components of the liquid-to-be-filtrated accumulated on the surface or in the pores of the separation membrane is calculated by performing a calculation step 1a, at least any one of a calculation step 1b and a calculation step 1c, and a calculation step 2 and/or a calculation step 3 in the followings, and repeatedly performing the calculation steps while updating time to calculate the amount of the constituent components of the liquid-to-be-filtrated adhered to the separation membrane:
the (calculation step 1a) of calculating an amount value of the constituent components of the liquid-to-be-filtrated adhered on the surface of the separation membrane at a time t+Δt (here, t is any number of 0 or more, and Δt is any positive number) based on an amount value of the constituent components of the liquid-to-be-filtrated and a membrane filtration flow rate (flux) value or a transmembrane pressure difference value at a time t;
the (calculation step 1b) of calculating an amount value of the constituent components of the liquid-to-be-filtrated present in the pores of the separation membrane at the time t+Δt based on the transmembrane pressure difference value and/or the membrane filtration flow rate (flux) value at the time t;
the (calculation step 1c) of calculating an amount value of the constituent components of the liquid-to-be-filtrated consolidated and adhered on the surface of the separation membrane at the time t+Δt based on the transmembrane pressure difference value at the time t;
the (calculation step 2) of calculating a membrane filtration resistance value at the time t+Δt based on the amount value of the constituent components of the liquid-to-be-filtrated adhered on the surface of the separation membrane, which is calculated in the calculation step 1a, and the amount value of the constituent components of the liquid-to-be-filtrated present in the pores of the separation membrane, which is calculated in the calculation step 1b, and/or the amount value of the constituent components of the liquid-to-be-filtrated consolidated and adhered on the surface of the separation membrane, which is calculated in the calculation step 1c; and
the (calculation step 3) of calculating a transmembrane pressure difference value at the time t+Δt based on the amount value of the constituent components of the liquid-to-be-filtrated adhered on the surface of the separation membrane, which is calculated in the calculation step 1a, and the amount value of the constituent components of the liquid-to-be-filtrated present in the pores of the separation membrane, which is calculated in the calculation step 1b, and/or the amount value of the constituent components of the liquid-to-be-filtrated consolidated and adhered on the surface of the separation membrane, which is calculated in the calculation step 1c, or based on the membrane filtration resistance value which is calculated in the calculation step 2.

7. The method for operating a separation membrane according to any one of 1 to 5, in which
the method for operating a separation membrane is an operation method for continuing membrane filtration while controlling a transmembrane pressure difference to a set value, and in the accumulated amount calculation step, the membrane filtration resistance or the amount of the constituent components of the liquid-to-be-filtrated accumulated on the surface or in the pores of the separation membrane is calculated by performing a calculation step 1a, at least any one of a calculation step 1b and a calculation step 1c, and a calculation step 2 and/or a calculation step 4 in the followings, and repeatedly performing the calculation steps while updating time to calculate the amount of the constituent components of the liquid-to-be-filtrated adhered to the separation membrane:
the (calculation step 1a) of calculating an amount value of the constituent components of the liquid-to-be-filtrated adhered on the surface of the separation membrane at a time t+Δt (here, t is any number of 0 or more, and Δt is any positive number) based on an amount value of the constituent components of the liquid-to-be-filtrated and a membrane filtration flow rate (flux) value or a transmembrane pressure difference value at a time t;
the (calculation step 1b) of calculating an amount value of the constituent components of the liquid-to-be-filtrated present in the pores of the separation membrane at the time t+Δt based on the transmembrane pressure difference value and/or the membrane filtration flow rate (flux) value at the time t;
the (calculation step 1c) of calculating an amount value of the constituent components of the liquid-to-be-filtrated consolidated and adhered on the surface of the separation membrane at the time t+Δt based on the transmembrane pressure difference value at the time t;
the (calculation step 2) of calculating a membrane filtration resistance value at the time t+Δt based on the amount value of the constituent components of the liquid-to-be-filtrated adhered on the surface of the separation membrane, which is calculated in the calculation step 1a, and the amount value of the constituent components of the liquid-to-be-filtrated present in the pores of the separation membrane, which is calculated in the calculation step 1b, and/or the amount value of the constituent components of the liquid-to-be-filtrated consolidated and adhered on the surface of the separation membrane, which is calculated in the calculation step 1c; and
the (calculation step 4) of calculating a membrane filtration flow rate (flux) value at the time t+Δt based on the amount value of the constituent components of the liquid-to-be-filtrated adhered on the surface of the separation membrane, which is calculated in the calculation step 1a, and the amount value of the constituent components of the liquid-to-be-filtrated present in the pores of the separation membrane, which is calculated in the calculation step 1b, and/or the amount value of the constituent components of the liquid-to-be-filtrated consolidated and adhered on the surface of the separation membrane, which is calculated in the calculation step 1c, or based on the membrane filtration resistance value which is calculated in the calculation step 2.

8. The method for operating a separation membrane according to any one of 1 to 7, in which
in the accumulated amount calculation step, an amount of inorganic constituent components of the liquid-to-be-filtrated accumulated on the surface and in the pores of the separation membrane is calculated.

9. The method for operating a separation membrane according to any one of 1 to 8, in which
the chemical liquid cleaning condition determined in the chemical liquid cleaning condition determination step is at least any of a chemical liquid concentration, a chemical liquid cleaning time, a chemical liquid temperature, a chemical liquid amount, a chemical liquid supply flow rate, a number of times of chemical liquid cleaning, a chemical liquid type, and a chemical liquid cleaning interval in the chemical liquid cleaning.

10. The method for operating a separation membrane according to any one of 1 to 9, in which
the chemical liquid type is changed when a calculation result of the restoration degree of the accumulated amount of the constituent components or the membrane filtration resistance of the chemical liquid cleaning is a specified value or less.

11. The method for operating a separation membrane according to any one of 1 to 10, in which
in the chemical liquid cleaning condition determination step, the chemical liquid concentration or the chemical liquid type is changed when a calculation result of the amount of the constituent components of the liquid-to-be-filtrated accumulated on the surface of the separation membrane or a calculation result of the amount of the constituent components of the liquid-to-be-filtrated accumulated in the pores of the separation membrane is a specified value or more.

12. The method for operating a separation membrane according to 11, in which
in the chemical liquid cleaning condition determination step, the chemical liquid concentration in the chemical liquid cleaning is increased when the calculation result of the amount of the constituent components of the liquid-to-be-filtrated accumulated on the surface of the separation membrane is the specified value or more, and at least an organic acid is selected as the chemical liquid type in the chemical liquid cleaning when the calculation result of the amount of the constituent components of the liquid-to-be-filtrated accumulated in the pores of the separation membrane is the specified value or more.

13. The chemical liquid cleaning method for a separation membrane according to any one of 1 to 12, in which
the chemical liquid cleaning is performed when a calculated value of the accumulated amount or the membrane filtration resistance of the liquid-to-be-filtrated, which is calculated in the accumulated amount calculation step, or a change rate over time of the calculated value reaches a specified value.

14. The method for operating a separation membrane according to any one of 1 to 13, in which
in the chemical liquid cleaning condition determination step, the chemical liquid cleaning condition is determined in consideration of an influence on filterability of the liquid-to-be-filtrated.

15. The method for operating a separation membrane according to any one of 1 to 14, in which
an operation includes a filtrating operation, a physical cleaning operation performed during the filtrating operation or in a state where the filtrating operation is stopped, and a chemical liquid cleaning operation performed in a state where the filtrating operation is stopped,
the method further includes:
a physical cleaning condition determination step of determining a physical cleaning condition based on the calculation result of the accumulated amount and a result of the chemical liquid cleaning effect calculation step; and
an operating condition control step of controlling the operating condition of the separation membrane based on a condition determined in the chemical liquid cleaning condition determination step and a condition determined in the physical cleaning condition determination step.

16. The method for operating a separation membrane according to 15, the method further including:
a prediction step of predicting a time at which a value of the accumulated amount or the membrane filtration resistance reaches a set value based on the calculation result of the accumulated amount of the liquid-to-be-filtrated, in which
the chemical liquid cleaning condition determined in the chemical liquid cleaning condition determination step and/or the physical cleaning condition determined in the physical cleaning condition determination step are changed based on a calculation result of the prediction step so that a reach time is a target time.

17. The method for operating a separation membrane according to 16, in which
the chemical liquid cleaning condition is determined by the chemical liquid cleaning condition determination step based on the calculation result of the prediction step so that the chemical liquid cleaning condition is within a specified value, and
next, a time at which a value of the accumulated amount or the membrane filtration resistance reaches a set value is predicted by the accumulated amount calculation step of the liquid-to-be-filtrated and the chemical liquid cleaning effect calculation step based on a condition after the chemical liquid cleaning condition is changed, and the operating condition is changed to the physical cleaning condition determined in the physical cleaning condition determination step so that the reach time is the target time.

18. The method for operating a separation membrane according to 16 or 17, in which
in a case where an increase in a predicted value of the accumulated amount or the membrane filtration resistance is large and the reach time is shorter than the target time in the calculation result of the prediction step,
the chemical liquid cleaning condition is determined in the chemical liquid cleaning condition determination step so that the reach time is the target time, and when the chemical liquid cleaning condition determined in the chemical liquid cleaning condition determination step is a set upper limit value and the reach time does not coincide with the target time,
next, the time at which the value of the accumulated amount or the membrane filtration resistance reaches the set value is predicted by the accumulated amount calculation step of the liquid-to-be-filtrated and the chemical liquid cleaning effect calculation step based on the condition after the chemical liquid cleaning condition is changed, and the operating condition is changed to the physical cleaning condition determined in the physical cleaning condition determination step so that the reach time is the target time.

19. The method for operating a separation membrane according to 16 or 17, in which
in a case where an increase in a predicted value of the accumulated amount or the membrane filtration resistance is large and the reach time is longer than the target time in the calculation result of the prediction step,
the physical cleaning condition is determined in the physical cleaning condition determination step so that the reach time is the target time, and when the physical cleaning condition determined in the physical cleaning condition determination step is a set lower limit value and the reach time does not coincide with the target time,
next, the time at which the value of the accumulated amount or the membrane filtration resistance reaches the set value is predicted by the accumulated amount calculation step of the liquid-to-be-filtrated and the chemical liquid cleaning effect calculation step based on the condition after the physical cleaning condition is changed, and the operating condition is changed to the chemical liquid cleaning condition determined in the chemical liquid cleaning condition determination step so that the reach time is the target time.

20 The method for operating a separation membrane according to any one of 15 to 17, in which
a chemical liquid cleaning cost calculation unit configured to calculate a chemical liquid cleaning cost related to the chemical liquid cleaning of the separation membrane based on the chemical liquid cleaning condition determined in the chemical liquid cleaning condition determination step, a power cost calculation unit configured to calculate a power cost related to an operation of the separation membrane based on the physical cleaning condition determined in the physical cleaning condition determination step, and an operation cost calculation unit configured to calculate an operation cost related to an operation of the separation membrane based on the chemical cost calculation unit and the power cost calculation unit are provided, and
the method further includes: an optimum operating condition determination step of selecting, based on the operation cost calculated by the operation cost calculation unit, an operating condition enabling cleaning with a low cost from operating conditions of the separation membrane determined in the operating condition determination step.

21. The method for operating a separation membrane according to any one of 15 to 20, in which
the physical cleaning condition determined in the physical cleaning condition determination step is at least any of an air flow rate, a reverse liquid cleaning flow rate, and a cleaning time.

22. A separation membrane device for filtrating a water-to-be-filtrated to obtain a filtrate, the separation membrane device including:
an initial value acquisition unit configured to acquire an initial value of an amount of constituent components of a liquid-to-be-filtrated accumulated in a separation membrane;
a data acquisition unit configured to acquire time-series change data of properties of the constituent components of the liquid-to-be-filtrated, time-series change data of the amount of the constituent components, and data indicating a time-series change in an operating condition of the separation membrane;
a calculation unit configured to calculate an amount of the constituent components of the liquid-to-be-filtrated accumulated on a surface and in pores of the separation membrane after the initial value is set;
a unit configured to calculate a restoration degree of an accumulated amount of the constituent components or membrane filtration resistance in chemical liquid cleaning based on a calculation result of the accumulated amount; and
a chemical liquid cleaning condition determination unit configured to determine a chemical liquid cleaning condition based on a result obtained by the calculation unit, in which
the chemical liquid cleaning is automatically performed based on the chemical liquid cleaning condition determined by the chemical liquid cleaning condition determination unit.

23. A program for determining operating conditions of a separation membrane so as to determine a chemical liquid cleaning condition for the separation membrane to filtrate a water-to-be-filtrated to obtain a filtrate, the program causing a computer to execute:
a step of acquiring an initial value of an amount of constituent components in a liquid-to-be-filtrated accumulated in the separation membrane;
a step of acquiring data indicating a time-series change in properties of the constituent components in the liquid-to-be-filtrated and an amount of the constituent components and data indicating a time-series change in an operating condition of the separation membrane after the initial value is set;
a step of integrating and calculating an amount of the constituent components in the liquid-to-be-filtrated accumulated on a surface and in pores of the separation membrane after the initial value is set;
a step of calculating a restoration degree of an accumulated amount of the constituent components or membrane filtration resistance in chemical liquid cleaning based on a calculation result of the accumulated amount; and
a step of determining the chemical liquid cleaning condition based on the calculation result.

24. A computer-readable recording medium storing the program for determining the operating conditions according to 23.

According to the present disclosure, it is possible to accurately grasp a fouling state of the separation membrane during chemical liquid cleaning, and by determining an optimum chemical liquid cleaning condition according to the fouling state, it is possible to prevent deterioration of the separation membrane and achieve optimization of a physical cleaning condition and a stable membrane filtration operation in a long period of time while reducing a chemical liquid cost. Further, since the chemical liquid cleaning condition can be determined in advance, it is possible to confirm an appropriate chemical liquid type and an appropriate chemical liquid amount in advance, and to prepare for confirmation of an inventory amount, ordering, and the like.

### BRIEF DESCRIPTION OF DRAWINGS

FIG. 1 is a device schematic flow diagram showing an example of a membrane separation device to which the present disclosure is applied.

FIG. 2 is a device schematic flow diagram showing another example of the membrane separation device to which the present disclosure is applied.

FIG. 3 is a conceptual diagram showing fouling of a separation membrane to which the present disclosure is applied.

FIG. 4 is an example of a flowchart showing a prediction method according to the present disclosure.

FIG. 5 is another example of a flowchart showing the prediction method according to the present disclosure.

FIG. 6 is a diagram showing an example of fouling resistance calculated according to the present disclosure.

FIG. 7 is an example of a flowchart showing a method for determining a cleaning condition according to a first embodiment of the present disclosure.

FIG. 8 is an example of a flowchart showing a method for determining a chemical liquid cleaning condition according to a second embodiment of the present disclosure.

FIG. 9 is an example of a flowchart showing a method for determining a chemical liquid cleaning condition according to a third embodiment of the present disclosure.

FIG. 10 is an example of a flowchart showing a method for determining a cleaning condition according to a fourth embodiment of the present disclosure.

FIG. 11 is an example of a flowchart showing a method for determining a cleaning condition according to a fifth embodiment of the present disclosure.

FIG. 12 is an example of a flowchart showing a method for determining a cleaning condition according to a sixth embodiment of the present disclosure.

FIG. 13 is an example of a flowchart showing a method for determining a cleaning condition according to a seventh embodiment of the present disclosure.

FIG. 14 shows an example of a prediction result according to the present disclosure.

### DETAILED DESCRIPTION OF EMBODIMENTS OF THE INVENTION

Hereinafter, the present disclosure will be described in more detail based on embodiments shown in the drawings. The present disclosure is not limited to the following embodiments.

A method for operating a separation membrane according to the present disclosure relates to a method for calculating a fouling amount at the time when a liquid-to-be-filtrated is filtrated by the separation membrane using a pressure difference (hereinafter, referred to as transmembrane pressure difference) between a liquid-to-be-filtrated side and a permeate side of the separation membrane as a drive force, and determining an operating condition such as a chemical liquid cleaning condition and a physical cleaning condition based on the calculation result.

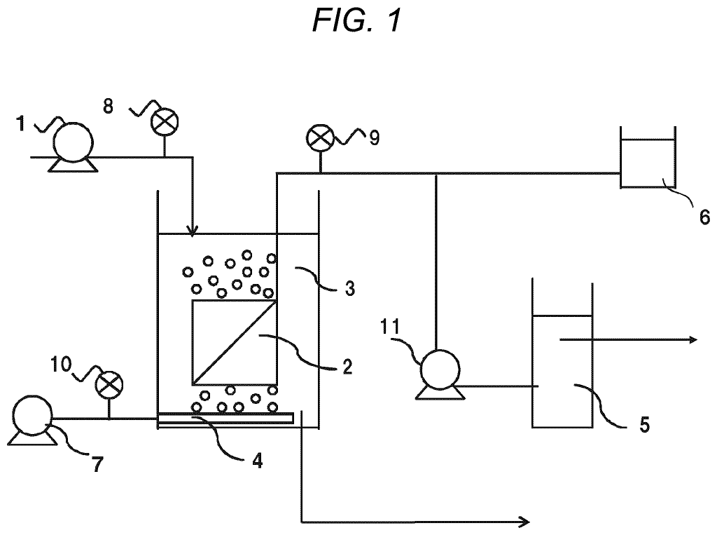

A membrane separation device to which the present disclosure is applied is provided with, for example, a submerged membrane separation unit 2, as shown in FIG. 1. In the present embodiment, a pump or the like may be provided between the submerged membrane separation unit 2 and a filtrate storage tank 5 in order to filter a liquid-to-be-filtrated by the submerged membrane separation unit 2, and a liquid surface of a filtrate in the filtrate storage tank 5 may be lower than a liquid surface of a liquid-to-be-filtrated in the liquid-to-be-filtrated tank 3 in order to perform filtration using a water head pressure difference as a drive force. In FIG. 1, a filtration operation is performed by a suction pump 11. A filtration time of the filtration operation is preferably set as appropriate according to properties of a raw liquid and a membrane filtration flux, but the filtration time may be continued until a predetermined membrane filtration pressure difference is reached. During the filtration operation or after the filtration operation is completed, air cleaning is performed in which air or the like is diffused by an air blower 7 to prevent adhesion of deposits on a surface of the separation membrane by air bubbles and an upward flow.

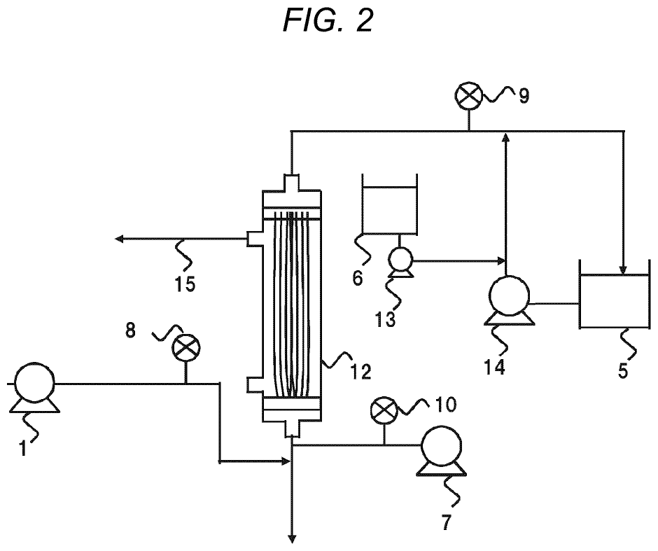

In another example, a membrane separation device to which the method for operating the membrane separation device according to the present disclosure is applied is provided with, for example, a liquid-to-be-filtrated supply pump 1 that supplies water-to-be-filtrated, a separation membrane module 12 that filtrates a liquid-to-be-filtrated, the filtrate storage tank 5 that stores a filtrate, a reverse liquid cleaning pump 14 that supplies the filtrate to the separation membrane module 12 to perform reverse liquid cleaning, a chemical liquid supply pump 13 that supplies a chemical liquid to water-to-be-filtrated or the separation membrane module, a chemical liquid storage tank 6 that stores a chemical liquid, the air blower 7 serving as an air supply source for air cleaning the separation membrane module 12, a liquid-to-be-filtrated flow meter 8, a filtrate flow meter 9, and an air flow meter 10, as shown in FIG. 2.

The liquid-to-be-filtrated is a liquid containing suspended substances and is subject to membrane filtration, and is not particularly limited. For example, in the case of a liquid containing microorganisms, since microorganisms and metabolites of the microorganisms are generally present as substances in the liquid-to-be-filtrated at a relatively high concentration, it is difficult to calculate fouling when the liquid-to-be-filtrated is subject to membrane filtration. However, in the present disclosure, since a fouling amount can be accurately calculated even in such a case, the present disclosure is particularly effective in a case where a liquid containing microorganisms such as a microorganism culture solution or activated sludge is used as the liquid-to-be-filtrated. The present disclosure is preferably applied to a case of a liquid-to-be-filtrated in which a concentration of suspended substances is 100 mg/L or more. A membrane filtration method may be a dead end filtration method in which membrane filtration is performed while concentrating a liquid-to-be-filtrated, or a cross-flow method in which membrane filtration is performed while generating a flow of a liquid-to-be-filtrated on a membrane surface. Even in a case where cleaning of the surface of the separation membrane is performed simultaneously or intermittently with filtration in which it is difficult to calculate a fouling amount by another method, the fouling amount can be calculated with high accuracy in the present disclosure, which is preferable.

The separation membrane has a function of capturing substances having particle diameter equal to or larger than a certain particle diameter and contained in a liquid-to-be-filtrated by applying pressure to the liquid-to-be-filtrated or suctioning the liquid-to-be-filtrated from a permeate side, and depending on a size of captured particles, the separation membrane may be a dynamic filtration membrane, a microfiltration membrane, an ultrafiltration membrane, a nanofiltration membrane, a reverse osmosis membrane, and the like. The separation membrane used in the present disclosure is preferably a microfiltration membrane or an ultrafiltration membrane. Examples of a shape of the separation membrane include, but are not limited to, a hollow fiber membrane, a flat membrane, a tubular membrane, and a monolith membrane. FIG. 1 shows a separation membrane device using a flat membrane, and FIG. 2 shows a separation membrane device using a hollow fiber membrane.

The operating method according to the present disclosure includes: calculating an amount of constituent components accumulated on a surface and in pores of a separation membrane after an initial value of an amount of the constituent components in a liquid-to-be-filtrated accumulated in the separation membrane is set, based on the initial value, a change over time in the constituent components in the liquid-to-be-filtrated, a change over time in the amount of the constituent components, and a change over time in an operating condition of the separation membrane after the initial value is set; and determining an operating condition such as a chemical liquid cleaning condition and a physical cleaning condition based on the calculation result.

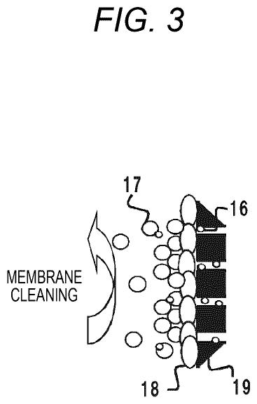

As shown in FIG. 3, fouling of the separation membrane caused by the constituent components in the liquid-to-be-filtrated can be divided into pore clogging 16 caused by the constituent components in the liquid-to-be-filtrated that entered pores of the membrane and have a diameter smaller than a pore diameter, and a cake caused by the constituent components in the liquid-to-be-filtrated that adhered on the surface of the separation membrane. It is preferable to subdivide and distinguish the fouling of the separation membrane into an amount of constituent components in the liquid-to-be-filtrated or an amount of membrane filtration resistance that can be removed under a specified physical cleaning condition, and an amount of constituent components in the liquid-to-be-filtrated or an amount of membrane filtration resistance that cannot be removed under a specified physical cleaning condition since a fouling state can be better grasped. That is, it is preferable to calculate a cake amount and cake resistance separately for a peelable cake 17 and an unpeelable cake 18. The peelable cake 17 adhered on the surface of the separation membrane is consolidated by applied pressure, and is converted into the unpeelable cake 18. Here, the specified physical cleaning condition is not limited, but is preferably a physical cleaning condition at the time of forming an unpeelable cake, and when the physical cleaning condition is changed, it is preferable to use an average value of physical cleaning conditions.

In the present disclosure, an accumulated amount in the liquid-to-be-filtrated is calculated by performing at least one of a calculation step 1a of calculating an amount of cakes adhered on the surface of the separation membrane at any time, a calculation step 1b of calculating a change amount of a pore clogging amount within a predetermined time, and a calculation step 1c of calculating a degree of consolidation of the cakes adhered on the surface of the separation membrane and a change amount of an unpeelable cake within a predetermined time, and a calculation step 2 of calculating a membrane filtration resistance value at any time, and/or a calculation step 3 of calculating a transmembrane pressure difference value at any time when the separation membrane continues membrane filtration while controlling a membrane filtration flow rate (flux) to a set value, or a calculation step 4 of calculating a membrane filtration flow rate (flux) value at any time when the separation membrane continues membrane filtration while controlling a transmembrane pressure difference value to a set value. A calculation method in each step will be described later, and amounts of cakes and pore clogging or membrane filtration resistance at any time are calculated in the above calculation steps. It is possible to determine an appropriate operating condition such as a chemical liquid cleaning condition and a physical cleaning condition according to a fouling state by determining the operating condition such as a chemical liquid cleaning condition and a physical cleaning condition based on a calculation result.

An evaluation condition is not particularly limited, but is preferably used to calculate a fouling amount when membrane filtration is continued while controlling the membrane filtration flow rate to the set value, or a fouling amount when membrane filtration is continued while controlling the transmembrane pressure difference to the set value.

Here, the transmembrane pressure difference is a pressure difference between a liquid-to-be-filtrated side and a permeate side of the separation membrane. A method for generating the transmembrane pressure difference includes, for example, a method for applying pressure to the liquid-to-be-filtrated side by a pump, a method for suctioning from the permeate side by a pump, and a method for using a water head difference between the liquid-to-be-filtrated side and the permeate side. The transmembrane pressure difference is generally measured as a difference between a pressure measurement value on the liquid-to-be-filtrated side and a pressure measurement value on the permeate side of the separation membrane, and at this time, it is preferable to measure or calculate a pressure loss generated by a hydraulic flow, and calculate and subtract the pressure loss from the difference between the pressure measurement value on the liquid-to-be-filtrated side and the pressure measurement value on the permeate side of the separation membrane. In the membrane separation activated sludge method, a difference between a pressure measurement value at the time of filtration and a pressure measurement value at the time of stopping filtration generally on the permeate side is generally measured in the method for suctioning from the permeate side by a pump.

The membrane filtration flow rate is a flow rate of a membrane filtrate, and the membrane filtration flux is a membrane filtration flow rate per unit area of the separation membrane.

The matter that the membrane filtration is continued while controlling the membrane filtration flow rate to the set value or the membrane filtration is continued while controlling the transmembrane pressure difference to the set value refers to control the membrane filtration flow rate or the transmembrane pressure difference to a predetermined set value. In the operating method, in order to continuously control the membrane filtration flow rate or the transmembrane pressure difference to be a certain value, the set value may be changed over time, as in a method for periodically or intermittently stopping filtration, a method for continuously or intermittently changing the membrane filtration flow rate or the transmembrane pressure difference, or the like. Examples of the method for continuing membrane filtration while controlling the membrane filtration flow rate to a set value include a method in which a suction pump or the like is installed on a membrane permeate side of the separation membrane to obtain a membrane filtrate, and a rotation speed of the suction pump is controlled by an inverter to control a flow rate. Examples of the method for continuing the membrane filtration while controlling the transmembrane pressure difference to a set value include a method in which pressure necessary for the membrane filtration is applied by a method for applying pressure to the liquid-to-be-filtrated side of the separation membrane, a method of using a water head difference, and the like, and the pressure is controlled.

The membrane filtration resistance is resistance generated when a liquid-to-be-filtrated is filtrated through a membrane, and is generally defined by Formula (1).

$$\begin{matrix}[ Formula 1 ] & \\ R = \frac{Δ P}{μ \times J} & ( 1 )\end{matrix}$$

Here, ΔP is transmembrane pressure difference [Pa], u is a membrane filtrate viscosity [Pa·s], R is membrane filtration resistance [1/m], and J is a membrane filtration flux [m/s].

Here, u may be obtained by directly measuring the viscosity of the membrane filtrate, but when the membrane filtrate is water or an aqueous liquid containing some solutes or the like, u may be converted from temperature according to Formula (2).

$$\begin{matrix}[ Formula 2 ] & \\ μ \times 1 {0}^{3} = F \times exp ( \frac{1 + BT}{CT + {DT}^{2}} ) & ( 2 )\end{matrix}$$

Here, F=0.01257187, B=−0.005806436, C=0.001130911, D=−0.000005723952, and T is an absolute temperature [K]. That is, when a Celsius temperature is o [° C.], T=G+273.15.

According to the present disclosure, initial values of the amount of constituent components in the liquid-to-be-filtrated accumulated in the separation membrane and the membrane filtration resistance are an amount of the constituent components in the liquid-to-be-filtrated accumulated in the separation membrane and membrane filtration resistance at the time when a calculation is started by integrating the membrane filtration resistance or the amount of the constituent components in the liquid-to-be-filtrated accumulated on the surface of the separation membrane and in pores of the separation membrane. At the time of starting up the separation membrane device, it is preferable to use 0 gC/m² as the initial value of the amount of the constituent components in the liquid-to-be-filtrated accumulated in the separation membrane, and it is preferable to use membrane filtration resistance at the time of production of the separation membrane as the initial value of the membrane filtration resistance. A value after the start-up of the separation membrane device can be calculated based on an operation history from the start-up of the separation membrane device to a time when the initial value is calculated. It is also preferable to use measured values obtained by periodically inspecting the separation membrane. The membrane filtration resistance may be a value obtained by measuring a membrane filtration resistance value at the time when pure water is permeated through the separation membrane periodically sampled, a membrane filtration resistance value after cleaning the separation membrane, or a virtual value based on a type of the separation membrane.

The amount of the constituent components in the liquid-to-be-filtrated refers to an amount of substances such as dissolved substances and suspended substances contained in the constituent components in the liquid-to-be-filtrated, and can be measured by, for example, total organic carbon (TOC), a chemical oxygen demand (COD), a biochemical oxygen demand (BOD), a floating solid concentration (SS), a dry weight, and a floating solid ignition loss (VSS). A value of the amount of the constituent components in the liquid-to-be-filtrated may be a measured value or a virtual value. The value of the amount of the constituent components in the liquid-to-be-filtrated or a change over time in the value of the amount of the constituent components in the liquid-to-be-filtrated may be predicted using an existing simulation model such as an IWA activated sludge model.

The set value of the membrane filtration flow rate (flux) is a set value of a membrane filtration flow rate or a membrane filtration flux, and may be a measured value, a specified value, a constant value, or a value that continuously or intermittently changes. The set value of the transmembrane pressure difference is a set value of transmembrane pressure difference, and may be a measured value, a virtual value, a constant value, or a value that continuously or intermittently changes.

Here, properties of the liquid-to-be-filtrated are represented by, for example, a viscosity, turbidity, pH, a sludge volume (SV) of activated sludge, and the like, and in the present disclosure, it is preferable to use a membrane filterability parameter that represents membrane filterability of the liquid-to-be-filtrated.

A change over time in the constituent components in the liquid-to-be-filtrated, a change over time in the amount of the constituent components, and a change over time in an operating condition of the separation membrane in the present disclosure may be design values or assumed values. For example, when designing the separation membrane device, an operating condition of the separation membrane device can be determined by using design values for the constituent components, the amount of the constituent components, and the operating condition of the separation membrane, or by setting the constituent components, the amount of the constituent components, and the operating condition of the separation membrane based on previous results.

A calculation method of integrating and calculating the membrane filtration resistance or the amount of the constituent components in the liquid-to-be-filtrated accumulated on the surface of the separation membrane and in pores of the separation membrane according to the present disclosure will be specifically described below, but the present disclosure is not limited to this calculation method.

When the membrane filtration is continued while controlling the membrane filtration flow rate to the set value, at least a calculation step 1a, and any of a calculation step 1b and a calculation step 1c, and a calculation step 2 and/or a calculation step 3 in the following are performed to obtain a membrane filtration resistance value and/or a transmembrane pressure difference value at any time.

That is, there are the following nine configurations of calculation steps for membrane filtration prediction when the membrane filtration is continued while controlling the membrane filtration flow rate to the set value.

(a1) calculation step 1a, calculation step 1b, calculation step 2, and calculation step 3, which will be described later

(a2) calculation step 1a, calculation step 1c, calculation step 2, and calculation step 3, which will be described later

(a3) calculation step 1a, calculation step 1b, calculation step 1c, calculation step 2, and calculation step 3, which will be described later.

(b1) calculation step 1a, calculation step 1b, and calculation step 2, which will be described later

(b2) calculation step 1a, calculation step 1c, and calculation step 2, which will be described later

(b3) calculation step 1a, calculation step 1b, calculation step 1c, and calculation step 2, which will be described later

(c1) calculation step 1a, calculation step 1b, and calculation step 3, which will be described later

(c2) calculation step 1a, calculation step 1c, and calculation step 3, which will be described later

(c3) calculation step 1a, calculation step 1b, calculation step 1c, and calculation step 3, which will be described later

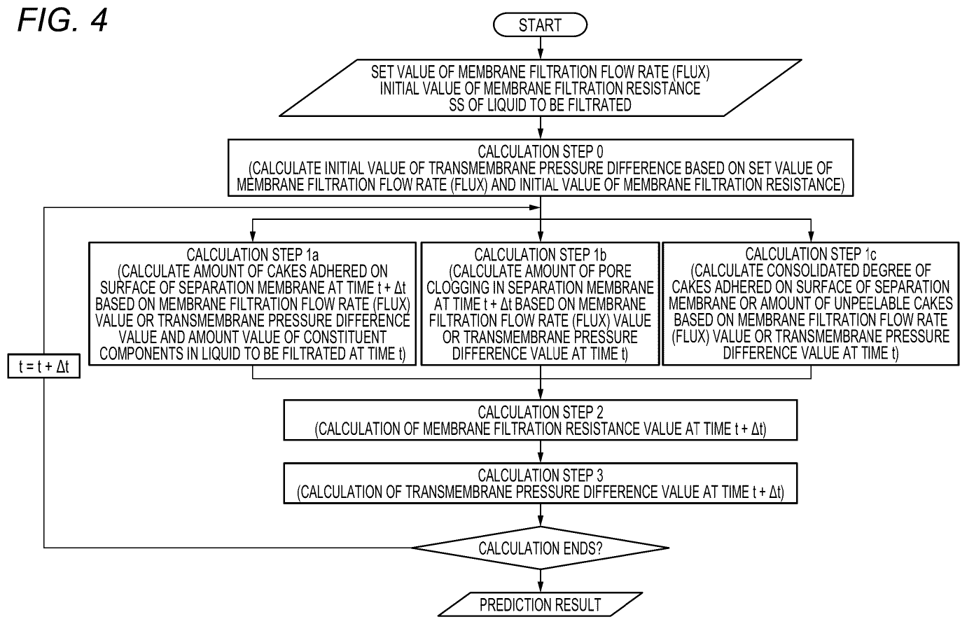

Here, in the case of (a3) (see FIG. 4), the membrane filtration resistance value and the transmembrane pressure difference value at any time can be obtained. In the case of (b3), the membrane filtration resistance value at any time can be obtained. In the case of (c3), the transmembrane pressure difference value at any time can be obtained.

Here, in the calculation step 1a, the amount of the constituent components (cakes) adhered on the surface of the separation membrane at any time is calculated.

Here, it is preferable that the calculation step 1a is a calculation step of calculating a change amount within a predetermined time in the amount of cakes adhered on the surface of the separation membrane, a calculation formula in the calculation step 1a includes a term of a speed at which a cake adheres on the surface of the separation membrane and a term of a speed at which a cake adhered on the surface of the separation membrane is peeled off from the surface of the separation membrane, the speed at which a cake adheres on the surface of the separation membrane is calculated using the transmembrane pressure difference value or the membrane filtration flow rate (flux) value, an amount of cakes, and/or a membrane cleaning power value, and the speed at which a cake is peeled off from the surface of the separation membrane is calculated using the transmembrane pressure difference value or the membrane filtration flow rate (flux) value, an amount of cakes adhered on the surface of the separation membrane, and/or a degree of consolidation of cakes. Accordingly, it is possible to accurately predict an amount of cakes adhered on the surface of the separation membrane at any time.

Here, the “degree of consolidation of cakes adhered on the surface of the separation membrane” refers to a degree of cakes being consolidated by pressure applied to the cakes adhered on the surface of the separation membrane. The amount of cakes adhered on the surface of the separation membrane can be more accurately predicted by calculating the amount of cakes adhered on the surface of the separation membrane using the degree of consolidation.

When the cakes are sufficiently consolidated, the cakes adhered on the surface of the separation membrane are not peeled off from the surface of the separation membrane by aeration cleaning. The sufficiently consolidated cakes are defined as unpeelable cakes, and the amount of cakes adhered on the surface of the separation membrane can be accurately calculated by using peelable cakes and unpeelable cakes instead of the degree of consolidation.

It is more preferable that a formula for obtaining the speed at which a cake adhered on the surface of the separation membrane is peeled off from the membrane surface includes a term based on a membrane cleaning power value. Here, the membrane cleaning power is a stress for peeling off a substance adhered on the surface of the separation membrane. A value of the membrane cleaning power is preferably a value of a shear force generated on the membrane surface, a value of a flow velocity of the liquid-to-be-filtrated in the membrane surface, and a value calculated based on the shear force and the flow velocity, or a value calculated based on a power value of a cleaning unit (the power value of the cleaning unit is, for example, an aeration air volume or an output value of an air blower when cleaning of the separation membrane is performed by aeration from a lower portion of the separation membrane), or the like, and the value of the membrane cleaning power may be calculated and estimated based on a result obtained by actually performing a membrane filtration test. Accordingly, it is possible to add an element that does not depend on performance of the separation membrane, such as aeration, as an element for determining a speed at which a cake adhered on the surface of the separation membrane is peeled off from the surface of the separation membrane, and thus it is easy to reflect an operating condition of a membrane filtration device.

A formula satisfying such a condition includes, for example, the following formulas (3) to (5), and in the present disclosure, it is recommended to follow the formulas (3) to (5). However, the scope of the present disclosure is not limited to the formulas (3) to (5).

$$\begin{matrix}[ Formula 3 ] & \\ \frac{{dX}_{c}}{dt} = X \cdot J \cdot ( 1 - {K}_{τ1} \cdot τ ) - γ \cdot ( τ - {K}_{τ 2} \cdot Δ P ) \cdot η \cdot ( {D}_{max} - D ) \cdot {X}_{c}^{2} & ( 3 )\end{matrix}$$

$$\frac{{dX}_{c}}{dt} = X \cdot J \cdot \frac{{K}_{τ 1}}{{K}_{τ 1} + τ} - γ \cdot τ \cdot \frac{{K}_{τ 2}}{{K}_{τ 2} + Δ P} \cdot η \cdot ( {D}_{max} - D ) \cdot {X}_{c}^{2} \qquad ( 4 )$$

$$\frac{{dX}_{c}}{dt} = X \cdot J \cdot \frac{{K}_{τ 1}}{{K}_{τ 1} + τ} - γ \cdot τ \cdot \frac{{K}_{τ 2}}{{K}_{τ 2} + Δ P} \cdot η \cdot {( {X}_{c} - {X}_{c , res} )}^{2} \qquad ( 5 )$$

provided that (1-Kτ1·τ)≥0 and (τ−Kτ2·ΔP)≥0 are satisfied.

Here, Xc is an amount of cakes adhered on the surface of the separation membrane per unit membrane area [gC/m²], t is a time [s], X is SS of a membrane separation tank [gC/m³], J is a membrane filtration flux [m/d], Kτ1 is a membrane cleaning power inhibition coefficient [-], y is a cake peel coefficient [1/m/s], t is a membrane cleaning power value [-], Kτ2 is a cake friction coefficient [1/Pa], ΔP is transmembrane pressure difference [Pa], η is a reciprocal of a density of the constituent components in the liquid-to-be-filtrated [m³/gC], Dmax is a maximum degree of consolidation [-] (generally 1), D is a degree of consolidation [-], Xc,res is an amount of unpeelable cakes [gC/m²]. “gC” represents a carbon weight. Here, on the right side of the formulas (3) to (5), a first term indicates a speed at which a cake adheres on the surface of the separation membrane, and a second term indicates a speed at which a cake is peeled off from the surface of the separation membrane. When the membrane cleaning power value t is expressed as a function of an aeration air volume or an output value of an air blower, the formulas (3) to (5) can be converted into calculation formulas related to the aeration air volume or the output value of the air blower by substituting the function into t.

As described above, in the case based on a calculation formula in which the change amount of cakes adhered on the surface of the separation membrane is expressed as a difference between the speed at which a cake is adhered to the separation membrane and the speed at which a cake is peeled off from the separation membrane, the change amount of cakes can be expressed as a differential formula related to an amount of cakes adhered to the separation membrane. In this case, an integration method for solving the differential formula includes a Euler method, a Runge-Kutta method, and a Runge-Kutta-Gill (RKG) method.

In the calculation step 1b, an amount of substances derived from the constituent components in the liquid-to-be-filtrated present in pores of the separation membrane (an amount of pore clogging) at any time is calculated.

Here, it is preferable that the calculation step 1b is a calculation step of calculating a change amount of the amount of pore clogging within a predetermined time and a value of the change amount is calculated based on the transmembrane pressure difference value and/or the membrane filtration flow rate (flux) and/or a value of an amount of cakes adhered on the surface of the separation membrane and/or a value of the amount of pore clogging. Accordingly, it is possible to accurately predict the amount of pore clogging at any time.

A formula satisfying such a condition includes, for example, the following formulas (6) to (9), and in the present disclosure, it is recommended to follow the formulas (6) to (9). However, the scope of the present disclosure is not limited to the formulas (6) to (9).

$$\begin{matrix}[ Formula 4 ] & \\ \frac{{dX}_{f}}{dt} = ϕ \cdot ( 1 - ε \cdot {X}_{f}^{2} ) \cdot Δ P & ( 6 )\end{matrix}$$

$$\frac{{dX}_{f}}{dt} = ϕ \cdot \frac{{K}_{f}}{{K}_{f} + {X}_{f}^{2 / 3}} \cdot {X}_{c}^{2} \cdot Δ P \qquad ( 7 )$$

$$\frac{{dX}_{f}}{dt} = ϕ \cdot \frac{{K}_{f}}{{K}_{f} + {X}_{f}^{2 / 3}} \cdot {X}_{c}^{2} \cdot J \qquad ( 8 )$$

$$\frac{{dX}_{f}}{dt} = λ \cdot {J}^{m} \cdot {X}_{c}^{b} \qquad ( 9 )$$

Here, Xf is an amount of pore clogging [gC/m²], v is a substance moving speed coefficient into pores of the separation membrane [gC/m²/Pa/s], ¿ is a movement inhibition coefficient of substance into pores of the separation membrane [m⁴/gC²], Kf is also a movement inhibition coefficient of substance into pores of the separation membrane [gC^{2/3}/m^{4/3}], λ is a pore clogging speed coefficient [s^{m-1}·gC^{1-b}/m^{2+m-2b}], m is a pore clogging flux dependency coefficient [-], and b is a pore clogging cake dependency coefficient [-].

In the calculation step 1c, the degree of consolidation of cakes adhered on the surface of the separation membrane at any time is calculated.

Here, it is preferable that a calculation formula in the calculation step 1c is a calculation step of calculating a change amount within a predetermined time of the degree of consolidation of the cakes adhered on the surface of the separation membrane, and a value of the change amount is calculated based on pressure applied to the cakes adhered on the surface of the separation membrane and/or a value of the degree of consolidation of the cakes adhered to the separation membrane. Accordingly, it is possible to accurately predict the degree of consolidation of the cakes adhered on the surface of the separation membrane at any time. Here, a pressure value derived from a cake, or the transmembrane pressure difference value may be used as the pressure applied to the cakes adhered on the surface of the separation membrane. In addition, consolidation may be expressed by using unpeelable cakes instead of the degree of consolidation of cakes.

A formula satisfying such a condition includes, for example, the following formula (10) or formula (11), and in the present disclosure, it is recommended to follow the formula (10) or formula (11). However, the scope of the present disclosure is not limited to the formula (10) or formula (11).

$$\begin{matrix}[ Formula 5 ] & \\ \frac{dD}{dt} = {k}_{1} \cdot ( {D}_{max} - D ) \cdot Δ {P}_{c} & ( 10 )\end{matrix}$$

$$\frac{{dX}_{c , res}}{dt} = k \cdot Δ {P}^{l} \cdot ( {X}_{c} - {X}_{c , res} ) \qquad ( 11 )$$

Here, D is a degree of consolidation [-], k1 is a consolidation rate coefficient [1/(Pa/s)], Dmax is a maximum degree of consolidation [-] (generally 1), ΔPc is a pressure value of a cake [Pa], k is a unpeelable cake formation speed coefficient [1/Pan/s], and 1 is a unpeelable cake pressure dependency coefficient [-].

In the calculation step 2, the membrane filtration resistance value at any time is calculated using the amount of cakes adhered to the separation membrane obtained in the calculation step 1a and/or the amount of pore clogging obtained in the calculation step 1b and/or the degree of consolidation of cakes adhered to the separation membrane or the amount of unpeelable cakes obtained in the calculation step 1c.

Here, in the calculation step 2, it is preferable that the membrane filtration resistance value at any time is calculated based on a value of pressure applied to cakes adhered on the surface of the separation membrane, and/or a high-order formula of a first and a second order formulas of an amount of pore clogging is included. Accordingly, the membrane filtration resistance value at any time can be more accurately predicted. Here, a pressure value derived from cakes adhered on the surface of the separation membrane, or the transmembrane pressure difference value may be set to the pressure applied to the cakes adhered on the surface of the separation membrane.

A formula satisfying such a condition includes, for example, the following formulas (12) to (14), and in the present disclosure, it is recommended to follow the formulas (12) to (14). However, the scope of the present disclosure is not limited to the formulas (12) to (14).

$$\begin{matrix}[ Formula 6 ] & \\ {R}_{c} = α \cdot ( 1 + a \cdot Δ {P}_{c} ) \cdot {X}_{c} & ( 12 )\end{matrix}$$

$${R}_{f} = β \cdot {X}_{f}^{1.5} \qquad ( 13 )$$

$$R = {R}_{m} + {R}_{c} + {R}_{f} \qquad ( 14 )$$

Here, Rc is membrane filtration resistance [1/m] derived from the cakes adhered on the surface of the separation membrane, a is a cake resistance coefficient [m/gC], a is a cake pressure dependency coefficient [m/gC/Pa], Rf is membrane filtration resistance [1/m] derived from pore clogging, B is a pore clogging filtration resistance coefficient [m²/gC^{1.5}], R is membrane filtration resistance [1/m], and Rm is an initial value of the membrane filtration resistance [1/m].

It is preferable that the cakes adhered on the surface of the separation membrane form a hierarchical structure, and the calculation step 1c includes the following calculation step 1c-1 and calculation step 1c-2.

(Calculation Step 1c-1) The layer number n of the cakes adhered on the surface of the separation membrane at any time is calculated based on the amount of cakes adhered to the separation membrane obtained in the calculation step 1a.

(Calculation Step 1c-2) A degree of consolidation of cakes in an i-th layer (here, i is any natural number of 1 to n, a first layer is closest to the separation membrane, and an n-th layer is farthest from the separation membrane) adhered on the surface of the separation membrane at any time is calculated.

Accordingly, it is possible to more accurately predict the amount of cakes adhered on the surface of the separation membrane and the membrane filtration resistance value.

Here, it is preferable that the calculation step 1a is a calculation step of calculating a change amount within a predetermined time in the amount of cakes adhered on the surface of the separation membrane, a calculation formula in the calculation step 1a includes a term of a speed at which a cake adheres on the surface of the separation membrane and a term of a speed at which a cake adhered on the surface of the separation membrane is peeled off from the surface of the separation membrane, the speed at which a cake adheres on the surface of the separation membrane is calculated by using the transmembrane pressure difference value or the membrane filtration flow rate (flux) value, and an amount of cakes and/or the membrane cleaning power value, and the speed at which a cake is peeled off from the surface of the separation membrane is calculated by using the transmembrane pressure difference value or the membrane filtration flow rate (flux) value, and an amount of cakes in the first to n-th layers adhered on the surface of the separation membrane, and/or a degree of consolidation of the cakes in the first to n-th layers. Accordingly, it is possible to accurately predict an amount of cakes adhered on the surface of the separation membrane at any time.

In the calculation step 1a, it is more preferable that a formula for obtaining the speed at which a cake adhered on the surface of the separation membrane is peeled off from the surface of the separation membrane includes a term of a function of a second or higher order for the amount of cakes in the first to n-th layers adhered on the surface of the separation membrane. Accordingly, it is possible to more accurately predict the amount of cakes adhered on the surface of the separation membrane at any time.

A formula satisfying such a condition includes, for example, the following formulas (15) to (17), and in the present disclosure, it is recommended to follow the formulas (15) to (17). However, the scope of the present disclosure is not limited to the formulas (15) to (17).

$$\begin{matrix}[ Formula 7 ] & \\ & ( 15 )\end{matrix}$$

$$\frac{{dX}_{c}}{dt} = X \cdot J \cdot ( 1 - {K}_{τ 1} \cdot τ ) - ( 1 - {D}_{i} ) \cdot γ \cdot ( τ - {K}_{τ 2} \cdot Δ P ) \cdot η \cdot {( {\sum }_{i = 1}^{n} ( ( {D}_{max} - {D}_{i} ) \cdot {X}_{c , i}^{2} ) )}^{2}$$

$$( 16 )$$

$$\frac{{dX}_{c}}{dt} = X \cdot J \cdot \frac{{K}_{τ 1}}{{K}_{τ 1} + τ} - ( 1 - {D}_{i} ) \cdot γ \cdot τ \cdot \frac{{K}_{τ 2}}{{K}_{τ 2} + Δ P} \cdot η \cdot {( {\sum }_{i = 1}^{n} ( ( {D}_{max} - {D}_{i} ) \cdot {X}_{c , i}^{2} ) )}^{2}$$

$$n = \frac{{X}_{c}}{{X}_{c , i}} \qquad ( 17 )$$

Here, n is the layer number of cakes adhered on the surface of the separation membrane [-], Di is a degree of consolidation of cakes in the i-th layer adhered on the surface of the separation membrane [-], and Xc,i is an amount of cakes per layer of cakes adhered on the surface of the separation membrane [gC/m^{2].}

In the calculation step 1c-2, a degree of consolidation of cakes in the i-th layer adhered on the surface of the separation membrane at any time is calculated.

Here, it is preferable that a calculation formula in the calculation step 1c includes a calculation step of calculating a change amount within a predetermined time of the degree of consolidation of the cakes in the i-th layer adhered on the surface of the separation membrane, and a value of the change amount is calculated based on the pressure applied to the cakes adhered on the surface of the separation membrane and/or a value of the degree of consolidation of the cakes in the i-th layer adhered to the separation membrane. Accordingly, it is possible to more accurately predict the degree of consolidation of the cakes in the i-th layer adhered on the surface of the separation membrane. Here, a pressure value derived from cakes adhered on the surface of the separation membrane, or the transmembrane pressure difference value may be set to the pressure applied to the cakes adhered on the surface of the separation membrane.

A formula satisfying such a condition includes, for example, the following formula (18), and in the present disclosure, it is recommended to follow the formula (18). However, the scope of the present disclosure is not limited to formula (18).

$$\begin{matrix}[ Formula 8 ] & \\ \frac{{dD}_{i}}{dt} = {K}_{1} \cdot ( {D}_{max} - {D}_{i} ) \cdot Δ {P}_{c} & ( 18 )\end{matrix}$$

It is preferable that the calculation step 2 is replaced with the following calculation step 2′. Accordingly, the membrane filtration resistance value at any time can be more accurately predicted.

(Calculation Step 2′) The membrane filtration resistance value at a time t+Δt is calculated based on the amount of pore clogging obtained in the calculation step 1b, the amount of cakes in the i-th layer adhered on the surface of the separation membrane, and/or the degree of consolidation of the cakes in the i-th layer adhered on the surface of the separation membrane obtained in the calculation step 1c.

A formula satisfying such a condition includes, for example, the following formulas (19) to (21), and in the present disclosure, it is recommended to follow the formulas (19) to (21). However, the scope of the present disclosure is not limited to the formulas (19) to (21).

$$\begin{matrix}[ Formula 9 ] & \\ {R}_{c} = {\sum }_{i = 1}^{n} ( ( 1 + {k}_{2} \cdot {D}_{i} ) \cdot α \cdot ( 1 + a \cdot Δ {P}_{c} ) \cdot {X}_{c , i} ) & ( 19 )\end{matrix}$$

$${R}_{f} = β \cdot {x}_{f}^{1.5} \qquad ( 20 )$$

$$R = {R}_{m} + {R}_{c} + {R}_{f} \qquad ( 21 )$$

Here, k₂ is a consolidation effect constant [-].

In the calculation step 3, the transmembrane pressure difference value at any time is calculated by using the amount of cakes adhered to the separation membrane obtained in the calculation step 1a and/or the amount of pore clogging obtained in the calculation step 1b and/or the degree of consolidation of cakes adhered to the separation membrane obtained in the calculation step 1c, or by using the membrane filtration resistance value obtained in the calculation step 2 or the calculation step 2′.

Here, when membrane filtration prediction is achieved by the above-described (c) (that is, the calculation step 1a and/or the calculation step 1b and/or the calculation step 1c, and the calculation step 3), the transmembrane pressure difference value at any time is calculated by using the amount of cakes adhered to the separation membrane obtained in the calculation step 1a and/or the amount of pore clogging obtained in the calculation step 1b and/or the degree of consolidation of cakes adhered to the separation membrane obtained in the calculation step 1c. As such a method, for example, a formula obtained by substituting the formulas (19) and (20) into the formula (21) and further substituting into the formula (1) may be used. When the membrane filtration prediction is achieved by the above-described (a) (that is, the calculation step 1a and/or the calculation step 1b and/or the calculation step 1c, the calculation step 2, and the calculation step 3), the transmembrane pressure difference value at any time is calculated by using the membrane filtration resistance value obtained in the calculation step 2. As such a method, it is preferable to perform a calculation using the formula (1) or a formula based on the formula (1).

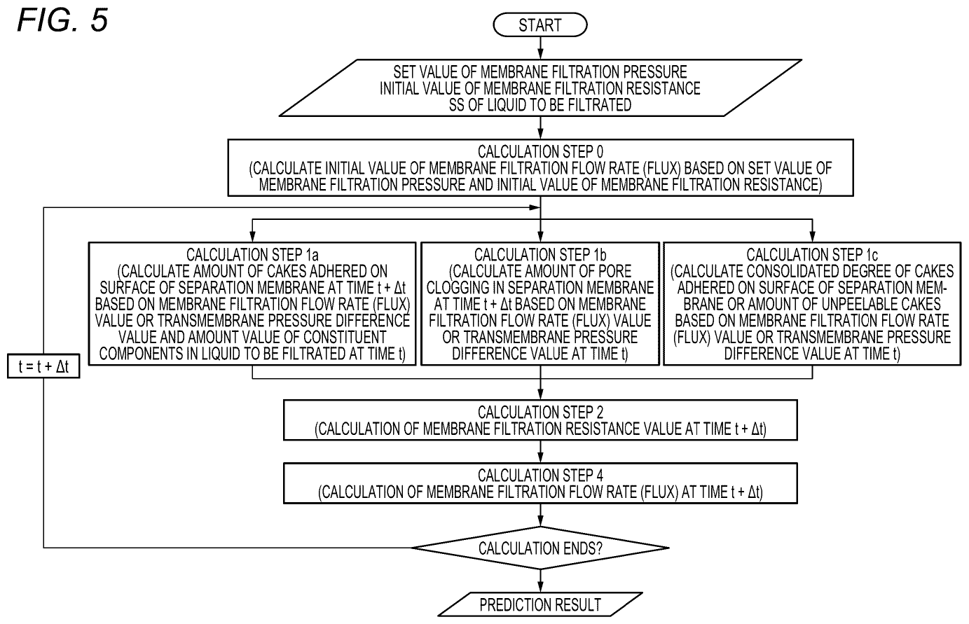

When the membrane filtration is continued while controlling the transmembrane pressure difference to a set value, the calculation step 4 is used instead of the calculation step 3, as shown in FIG. 5. In the calculation step 4, the membrane filtration flow rate (flux) value at any time is calculated by using the amount of cakes adhered to the separation membrane obtained in the calculation step 1a and/or the value of the amount of cakes present in pores of the separation membrane obtained in the calculation step 1b and/or the degree of consolidation of cakes adhered to the separation membrane obtained in the calculation step 1c, or by using the membrane filtration resistance value obtained in the calculation step 2 or the calculation step 2′.

Here, when membrane filtration prediction is achieved by the above-described (f) (that is, the calculation step 1a and/or the calculation step 1b and/or the calculation step 1c, and the calculation step 4), the membrane filtration flow rate (flux) value at any time is calculated by using the amount of cakes adhered to the separation membrane obtained in the calculation step 1a and/or the value of the amount of pore clogging obtained in the calculation step 1b and/or the degree of consolidation of cakes adhered to the separation membrane obtained in the calculation step 1c. As such a method, for example, a formula obtained by substituting the formulas (17) and (18) into the formula (19) and further substituting into the formula (1) may be used. When the membrane filtration prediction is achieved by the above-described (d) (that is, the calculation step 1a and/or the calculation step 1b and/or the calculation step 1c, the calculation step 2, and the calculation step 4), the membrane filtration flow rate (flux) value at any time is calculated by using the membrane filtration resistance value obtained in the calculation step 2. As such a method, it is preferable to perform a calculation using the formula (1) or a formula based on the formula (1).

In the present disclosure, it is preferable to calculate the membrane filtration resistance or the amount of the constituent components in the liquid-to-be-filtrated derived from inorganic substances that are accumulated on the surface and in pores of the separation membrane. A calculation method is not limited, and it is preferable to perform the calculation by multiplying an amount of inorganic substances contained in the liquid-to-be-filtrated by a filtration amount and a coefficient, or perform the calculation by multiplying a ratio between an amount of inorganic substances and an amount of organic substances in the liquid-to-be-filtrated by the amount of cakes or the amount of pore clogging, or cake resistance or pore clogging resistance. Furthermore, in the case of chemical liquid cleaning using sodium hypochlorite, it is preferable to use the number of times of cleaning using the sodium hypochlorite in the calculation assuming that inorganic substances in the liquid-to-be-filtrated partially precipitate on the membrane surface. Here, an amount of inorganic substances in the liquid-to-be-filtrated may be estimated based on electric conductivity, or may be calculated based on a dry weight or VSS/SS by performing a water quality analysis. A concentration of iron, manganese, aluminum, calcium, silica, or the like that is likely to precipitate and adhere on the membrane surface may be used as a concentration of the inorganic substances in the liquid-to-be-filtrated.

Time-series data is used for a filtration flux, SS of the liquid-to-be-filtrated, properties or an amount of constituent components in the liquid-to-be-filtrated such as a membrane filterability parameter, and a value of an operating condition used in a calculation according to the present disclosure. The time-series data may be a measured value, a virtual value, a constant value, or a value that continuously or intermittently changes. When a previous fouling amount is calculated, it is possible to calculate the fouling amount more accurately by using a measured value.

When a future fouling amount or membrane filtration resistance is calculated, it is preferable that time-series fluctuation patterns of time-series change data of properties of the constituent components in the liquid-to-be-filtrated, time-series change data of an amount of the constituent components, and time-series change data of an operating condition of the separation membrane used in a calculation can be predicted based on respective previous measured values, and accuracy can be improved by using predicted time-series fluctuation patterns. A prediction method of the time-series fluctuation patterns according to the present disclosure is not limited, and machine learning and artificial intelligence may be used.

In the calculation step 1a, the calculation step 1b, the calculation step 1c, the calculation step 2, the calculation step 3, and the calculation step 4, calculations are performed according to predetermined calculation formulas, and the calculation formulas may include a parameter other than values, data, and substance amounts described in the above explanation of the calculation steps. In such a case, it is necessary to determine a value of the parameter when performing the calculations in the calculation steps. In the present disclosure, a method for determining the value of the parameter is not particularly limited, and it is preferable to actually filtrate the liquid-to-be-filtrated using a separation membrane having the same material and shape as the separation membrane of the membrane filtration device, measure or calculate a change in a value of the transmembrane pressure difference, a value of the membrane filtration flux or the membrane filtration flow rate, and a value of the membrane filtration resistance at that time, and estimate or determine the parameter based on results of the measurement or calculation. This is because the above-described parameter includes many membrane filterability parameters determined by properties of a liquid-to-be-filtrated and a separation membrane to be used, and the prediction can be performed with high accuracy by following the method for estimating or determining the parameter.

Examples of the membrane filterability parameters include, but are not particularly limited to, parameters related to a calculation of any of a cake adhering speed, a cake peeling-off speed, cake resistance, an unpeelable cake formation speed, unpeelable cake resistance, a progress speed of pore clogging of the separation membrane, and resistance caused by pore clogging of the separation membrane.

It is preferable to use a method capable of automatically acquiring the membrane filterability parameters in line since the membrane filterability parameters can be acquired easily and frequently and time-series change data of the membrane filterability parameters can be acquired in more detail. The method capable of automatically acquiring the membrane filterability parameters in line includes, for example, a method in which the liquid-to-be-filtrated is imaged by an optical unit (an optical microscope or the like) and an imaging unit (a camera or the like) and the membrane filterability parameters are calculated based on image information obtained by processing an imaged image.

In the present disclosure, a frequency of calculating a fouling amount is not limited, and a constant value may be used as the frequency. Since there is no large change in a calculation result when properties of the constituent components in the liquid-to-be-filtrated are stable, and there are changes in the calculation result when the membrane filterability of the liquid-to-be-filtrated changes, it is preferable to obtain the changes over time at a timing when the properties of the constituent components in the liquid-to-be-filtrated change. That is, when the membrane filterability parameters deviate from a predetermined reference range or a predetermined change rate range, it is preferable to calculate the fouling amount to quickly respond to a change in the properties of the constituent components.

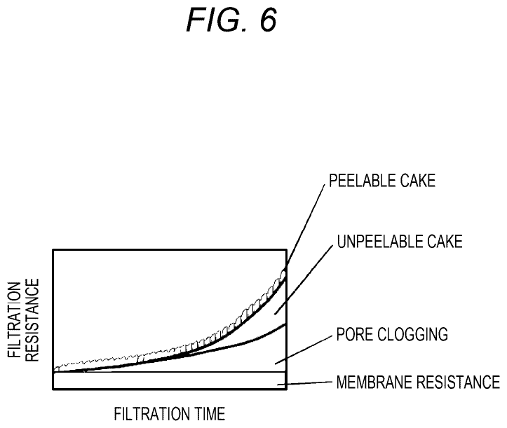

FIG. 6 shows an example of a fouling resistance calculation result predicted as described above. In the present disclosure, an operating condition such as a chemical liquid cleaning condition and a physical cleaning condition is determined and controlled based on the above calculation results.

Physical cleaning determined in the present disclosure is at least one operation of cleaning the membrane surface of the separation membrane between a flushing operation of forcibly causing one or both of a liquid and a gas to flow on a primary side surface of the separation membrane and a reverse liquid cleaning operation of supplying a liquid from a secondary side to the primary side of the separation membrane, and the physical cleaning condition determined in the present disclosure is at least one of a flow rate, a time, and a cleaning interval of the gas or the liquid in the flushing operation, a flow rate, a time, and a cleaning interval of the liquid in the reverse liquid cleaning operation, and a supply flow rate, a time, and a cleaning interval in the reverse liquid cleaning operation. Vapor is preferably used as the gas used in the flushing operation, in addition to air. Further, it is preferable to use a gas from which oil and mist are removed, in order to reduce a risk that oil and the like adheres to the separation membrane. A flow rate of the gas used in the flushing operation can be appropriately set depending on a form of a membrane module, but when the flow rate is too small, a sufficient cleaning effect cannot be obtained and the membrane filtration resistance is increased, and when the flow rate is too large, the gas becomes a factor of causing breakage or deterioration of the membrane module and a power cost is increased. Therefore, it is preferable to set the flow rate to about 10 Nm³/h to 400 Nm³/h per membrane module.

The reverse liquid cleaning operation is, for example, a cleaning operation in which filtrate is supplied from the secondary side of the separation membrane to the primary side of the separation membrane by the reverse liquid cleaning pump 14, and suspended substances adhered on the membrane surface or in the membrane pores are removed. A liquid to be supplied is composed of a filtrate and/or a clear liquid, and it is effective to control a liquid feeding flow rate and time in the reverse liquid cleaning according to a filtration flow rate.

An intensity of the physical cleaning can be increased by performing at least one of operations of increasing the flow rate and time of the gas or the liquid in the flushing operation, increasing the flow rate and time of the liquid in the reverse liquid cleaning operation, and shortening cleaning intervals in the flushing operation and the reverse liquid cleaning operation, and the intensity of the physical cleaning can be reduced by performing at least one of operations of decreasing the flow rate and time of the gas or the liquid in the flushing operation, decreasing the flow rate and time of the liquid in the reverse liquid cleaning operation, and prolonging cleaning intervals in the flushing operation and the reverse liquid cleaning operation.

A time at which a value of an accumulated fouling amount or the membrane filtration resistance reaches a set value is predicted using the above calculation method, and the physical cleaning condition in the present disclosure is determined such that a reach time is a target time.

The chemical liquid cleaning determined in the present disclosure is an operation of supplying a chemical liquid to the separation membrane to clean the separation membrane. In particular, when a large amount of microorganisms are contained in the liquid-to-be-filtrated, such as in a membrane separation activated sludge method, it is known that a phenomenon occurs in which the microorganisms grow on the membrane surface or microorganism metabolites accumulate to form a biofilm, thereby rapidly increasing the transmembrane pressure difference, and it is effective to periodically perform the chemical liquid cleaning before the transmembrane pressure difference rapidly increases. Specifically, it is preferable to perform the chemical liquid cleaning when a calculated value of the accumulated amount or the membrane filtration resistance calculated in the accumulated amount calculation step, or a change rate over time of the calculated value reaches a specified value, or when a time is a predicted reach time.

A method for injecting a chemical liquid in the present disclosure is not limited. In the membrane separation device using the submerged membrane separation unit shown in FIG. 1, the chemical liquid is preferably injected from a permeate side (the secondary side) to a liquid-to-be-filtrated side (the primary side) of the separation membrane in a state where a membrane module is immersed in the liquid-to-be-filtrated after a filtration operation is stopped. A method of bringing the chemical liquid into contact with the separation membrane includes a method of taking out the entire membrane module from a membrane separation tank and immersing the membrane module in a chemical liquid cleaning tank, and a method of emptying the membrane separation tank and then storing the chemical liquid in the tank to bring the membrane into contact with the chemical liquid. When a necessary auxiliary device is large, it is not economical.

The chemical liquid is stored in the chemical liquid storage tank 6, and supplied to the permeate side of the membrane module using a water head difference or a pump (a method of providing the chemical liquid storage tank on the ground and supplying the chemical liquid to a chemical liquid tank may be used). Here, the chemical liquid used for cleaning may be used according to a fouling state of the membrane, and it is preferable to use sodium hypochlorite for fouling caused by organic substances, and use an organic acid having a chelating effect such as oxalic acid and citric acid for fouling caused by inorganic substances since the sodium hypochlorite and the organic acid are effective in restoring membrane properties.

The chemical liquid cleaning condition determined in the present disclosure includes at least one of a chemical liquid concentration, a chemical liquid cleaning time, a chemical liquid temperature, a chemical liquid amount, a chemical liquid supply flow rate, the number of times of chemical liquid cleaning, a chemical liquid type, and a chemical liquid cleaning interval in the chemical liquid cleaning. An intensity of the chemical liquid cleaning can be increased by performing at least one of operations of increasing a chemical liquid concentration, a chemical liquid cleaning time, a chemical liquid temperature, a chemical liquid amount, a chemical liquid supply flow rate, and the number of times of the chemical liquid cleaning or shortening a cleaning interval, and the intensity of the chemical liquid cleaning can be reduced by performing at least one operations of reducing a chemical liquid concentration, a chemical liquid cleaning time, a chemical liquid temperature, a chemical liquid amount, a chemical liquid supply flux, and the number of times of the chemical liquid cleaning or increasing a cleaning interval. It is preferable that a time at which a value of the accumulated fouling amount or the membrane filtration resistance reaches a set value in an operation after the chemical liquid cleaning is predicted using the above calculation method, and the chemical liquid cleaning condition is determined such that a reach time is a target time. It is preferable that a restoration degree of the accumulated fouling amount or the membrane filtration resistance in the chemical liquid cleaning is calculated based on a calculation result of the accumulated fouling amount or the membrane filtration resistance, and the chemical liquid cleaning condition is calculated based on a calculation result of the restoration degree. Here, the restoration degree may be either a reduction amount or a reduction rate of the accumulated fouling amount or the membrane filtration resistance. When a chemical liquid concentration is high, a reaction between a chemical liquid and a fouling substance is promoted, and thus a fouling removal rate increases. However, the membrane deteriorates, and an influence on properties of the liquid-to-be-filtrated in the membrane separation tank or a chemical liquid cost increases due to an increase in the chemical liquid concentration, and thus it is preferable that an effective chlorine concentration of the sodium hypochlorite is about 100 mg/L to 6000 mg/L, and a concentration of the oxalic acid or citric acid is about 1 mass % to 3 mass %. When the chemical liquid cleaning time is long, a contact time and a reaction time between the chemical liquid and the fouling substance can be increased, and the fouling removal rate increases. However, since a concentration of an injected chemical liquid on the membrane surface is reduced due to consumption, diffusion, and the like in a reaction, an effect is lowered when the chemical liquid cleaning is immoderately performed for a long time, and an operation rate of the separation membrane device is also lowered. Therefore, a chemical liquid cleaning time is preferably set to about 20 minutes to 120 minutes. When the chemical liquid temperature is high, a reaction rate between the chemical liquid and the fouling substance increases, and thus a fouling removal rate increases in the same chemical liquid cleaning time. However, since an excessive increase in the chemical liquid concentration may affect properties of the liquid-to-be-filtrated or cause membrane deterioration, the chemical liquid temperature is preferably set to about 10° C. to 40° C. When the chemical liquid amount and the chemical liquid supply flow rate are large, a permeation flow rate and a permeation flow velocity from the secondary side to the primary side increase, and pore clogging or a cake is easily peeled by the increased amount, and a fouling removal rate increases. A fouling substance that was not removed at once is removed by repeating cleaning, and thus a fouling removal rate increases. In consideration of these influences, it is preferable to create a calculation formula of a restoration degree as a function.

Here, although the restoration degree of the accumulated amount or the membrane filtration resistance of respective cakes and the pore clogging may be calculated using the same chemical liquid cleaning effect calculation formula, since contribution rates to restoration rates of respective chemical liquid cleaning conditions are different, it is preferable to use different calculation formulas. In particular, it is preferable to set specified values of accumulated amounts respectively to cakes and pore clogging, and determine a chemical liquid condition by comparing with the specified values. In particular, a cake can be efficiently removed by bringing the cake into contact with a chemical liquid having a high concentration, and on the other hand, inorganic substances often accumulate in pores, and it is effective to perform chemical liquid cleaning using organic acids to restore pore clogging. Table 1 shows an example of a method for determining a chemical liquid cleaning condition. First, a specified value A of a cake accumulated amount and a specified value B of pore clogging are compared with a cake amount Xc adhered on the surface of the separation membrane and a pore clogging amount Xf that are calculated in the accumulated amount calculation step. Here, when the amount of cakes adhered on the surface of the separation membrane is the specified value or more, that is, when Xc>A, chemical liquid cleaning is performed using high-concentration sodium hypochlorite. On the other hand, when the amount of cakes adhered on the surface of the separation membrane is less than the specified value, that is, when Xc<A, chemical liquid cleaning is performed using low-concentration sodium hypochlorite. In addition, when the pore clogging amount is the specified value or more, that is, when Xf≥B, chemical liquid cleaning using an organic acid is performed after chemical liquid cleaning using sodium hypochlorite. On the other hand, when the pore clogging amount is less than the specified value, that is, when Xf<B, only chemical liquid cleaning using sodium hypochlorite is performed. Accordingly, it is possible to easily determine a concentration and a chemical type to be used in chemical liquid cleaning, and it is possible to effectively improve a restoration degree by the chemical liquid cleaning.

TABLE 1

| Determination | Accumulated amount of cakes | Accumulated amount of pore clogging |
|---|---|---|
| Specified value | Cleaning using high-concentration | Perform chemical liquid cleaning using citric |
| or more | hypochlorous acid | acid after chemical liquid cleaning using |
| | | hypochlorous acid |
| Specified value | Cleaning using low-concentration | Perform only chemical liquid cleaning using |
| or less | hypochlorous acid | hypochlorous acid |

It is known from previous studies that a restoration degree of pore clogging tends to be smaller than that of cakes by chemical liquid cleaning, and it is preferable to use a calculation formula in which a removal rate or a removal amount of pore clogging is smaller than a removal rate or a removal amount of cakes. Further, it is preferable to calculate a ratio between an accumulated amount or membrane filtration resistance of cakes and an accumulated amount or membrane filtration resistance of pore clogging, and determine the chemical liquid cleaning condition based on the ratio. Further, it is preferable to use a calculation formula such that a contribution rate by a cleaning flow rate and a chemical liquid supply flow rate is larger than that of cakes because it more closely simulates an actual phenomenon.

It is preferable to create a chemical liquid cleaning effect calculation formula including a fouling influence of inorganic substances. Specific examples of creating such a calculation formula include a method in which different calculation formulas are used for a chemical liquid cleaning effect calculation formula using sodium hypochlorite and a chemical liquid cleaning effect calculation formula using organic acid cleaning, a method in which different calculation formulas are used for chemical liquid cleaning effect calculation formulas of a fouling amount and membrane filtration resistance derived from inorganic substances, and a method in which an inhibition term is provided in a calculation formula such that a cleaning restoration degree is reduced according to an accumulated amount of inorganic substances during chemical liquid cleaning using sodium hypochlorite. It is preferable to calculate the restoration degree in the chemical liquid cleaning effect calculation formula in consideration of a fouling influence of inorganic substances, and determine a type of a chemical liquid according to a result of the calculation, so that fouling substances inside and outside the membrane can be efficiently removed. Specifically, when a calculation result of the chemical liquid cleaning effect using sodium hypochlorite is a specified value or less, it is preferable to use an organic acid as the chemical liquid type used in the chemical liquid cleaning to remove inorganic substance fouling.

A formula satisfying such a condition includes, for example, the following formula (22) or formula (23), and it is recommended to follow the formula (22) or formula (23) in the present disclosure. However, the scope of the present disclosure is not limited to the formula (22) or formula (23).

$$\begin{matrix}[ Formula 10 ] & \\ {r}_{c} = {C}^{j} \cdot {t}_{c}^{i} \cdot {T}_{c}^{h} \cdot {V}^{g} \cdot {X}_{c}^{f} \cdot {X}_{f}^{e} \cdot \text{?} & ( 22 )\end{matrix}$$

$${r}_{f} = θ \cdot {r}_{c} \qquad ( 23 )$$

$$\text{?} \text{indicates text missing or illegible when filed}$$

Here, rc is a cake cleaning restoration rate using sodium hypochlorite [-], Cis a chemical liquid concentration [mg/L], tc is a chemical liquid cleaning time [s], Tc is a chemical liquid temperature [° C.], V is a chemical liquid amount per unit film area [L/m²], Xi is an inorganic substance accumulated amount per unit film area [gC/m²], rf is a pore clogging cleaning restoration rate using sodium hypochlorite [-], θ is a pore clogging cleaning restoration coefficient [-], j, i, h, g, e, d are coefficients indicating contribution rates of respective items [-]. It is preferable to set these coefficients based on previous actual results, and correct these coefficients as appropriate according to a chemical liquid cleaning restoration degree in most recent chemical liquid cleaning.

A timing when chemical liquid cleaning is performed is generally a timing when the transmembrane pressure difference (or the membrane filtration resistance) rises to a certain value or more, or a timing after a membrane module is operated for a certain period of time, but the chemical liquid cleaning is not necessarily performed at these timings, and may be performed at any timing. Since excessive chemical liquid cleaning causes deterioration of the separation membrane, a property change of the liquid-to-be-filtrated in the membrane separation tank, an increase in a chemical liquid cost, and a reduction in an operation rate of the separation membrane device, the chemical liquid cleaning is preferably performed at an interval of about one day to several weeks.

The property change of the liquid-to-be-filtrated in the membrane separation tank due to the chemical liquid cleaning has a large influence particularly when a liquid containing microorganisms such as a microorganism culture solution or activated sludge is used as the liquid-to-be-filtrated. Here, when these are used as the liquid-to-be-filtrated, it is preferable to calculate a degree of the property change due to the chemical liquid cleaning and determine a chemical liquid cleaning condition within a range in which a calculation result falls within a specified value. In particular, since a chemical liquid concentration greatly contributes to a chemical liquid cleaning effect and a property change of the liquid-to-be-filtrated, it is preferable to preferentially determine the chemical liquid concentration in a range in which a calculation result of the property change falls within a specified value in a chemical liquid condition determination step. Although not limited, a chemical liquid cleaning condition is preferably determined in order of a chemical liquid concentration, a chemical liquid cleaning time, and a chemical liquid frequency based on a chemical liquid cleaning effect and a contribution rate to the property change of the liquid-to-be-filtrated.

Here, when a concentration of a chemical liquid used in the chemical liquid cleaning is high or when an amount of the chemical liquid is large, a sterilization effect of the chemical liquid and a pH change of the liquid-to-be-filtrated increase, and an influence on microorganisms increases. It is preferable to take these effects into consideration in the chemical liquid concentration in the membrane separation tank, which is a value obtained by multiplying the chemical liquid concentration by a chemical liquid amount flowing into the separation membrane tank during the chemical liquid cleaning and dividing the product by a volume of the membrane separation tank. When the chemical liquid temperature is high, since a reaction rate between a chemical liquid and microorganisms increases, an influence on the microorganisms increases in the same cleaning time. On the other hand, when an SS concentration in the separation membrane tank is high, since a chemical liquid amount relative to an amount of microorganisms is relatively small at the same chemical liquid amount, an influence on the microorganisms is reduced. Immediately after the chemical liquid cleaning, an influence of the chemical liquid cleaning on the microorganisms is large and the membrane filterability significantly deteriorates, but the membrane filterability is restored in a later operation. Here, when a temperature of the liquid-to-be-filtrated is high, microorganism activity is high, and a restoration speed is large. When an organic substance load is high, a restoration speed is large, but when the organic substance load is too high, properties of the liquid-to-be-filtrated deteriorate due to a treatment failure. Therefore, it is preferable to set a concentration of the organic substance load to about 0.05 kg. BOD/kg·SS/d to 0.15 kg·BOD/kg·SS/d.

A formula for calculating such a change degree of the properties of the liquid-to-be-filtrated in the membrane separation tank due to the chemical liquid cleaning includes, for example, the following formula (24) or formula (25), and it is recommended to follow the formula (24) or formula (25). However, the scope of the present disclosure is not limited to the formula (24) or formula (25).

$$\begin{matrix}[ Formula 11 ] & \\ {r}_{p , 0} = {K}_{p 1} \cdot {C}_{t}^{p} \cdot {T}_{t}^{q} \cdot {X}^{s} & ( 24 )\end{matrix}$$

$${r}_{p} = ( 1 - {K}_{p 2} \cdot {T}_{t}^{u} \cdot {L}^{v} \cdot ln ( {t}_{w} ) ) \cdot {r}_{p , 0} \qquad ( 25 )$$

Here, rp,0, and rp are liquid-to-be-filtrated property influence degrees [-], Kp1 and Kp2 are liquid-to-be-filtrated property influence coefficients [-], Ct is a chemical liquid concentration [mg/L] in the membrane separation tank during the chemical liquid cleaning, Tt is a temperature [° C.] in the membrane separation tank, L is an organic substance load amount [gC/g/d] relative to the liquid-to-be-filtrated in the membrane separation tank, and p, q, s, u, and v are coefficients indicating contribution rates of respective items [-]. It is preferable to set these coefficients based on previous actual results. Here, prediction can be performed with high accuracy in consideration of the property change of the liquid-to-be-filtrated by calculating the membrane filtration resistance or the amount of the constituent components in the liquid-to-be-filtrated accumulated in the separation membrane by multiplying a membrane filterability parameter by the calculated liquid-to-be-filtrated property influence degree rp. In particular, in the chemical liquid cleaning condition determination step, it is preferable to reflect the property change in the liquid-to-be-filtrated due to the chemical liquid cleaning, predict behaviors of the amount of the constituent components in the liquid-to-be-filtrated accumulated on the surface of the separation membrane and in pores of the separation membrane, the membrane filtration resistance, or the transmembrane pressure difference after the chemical liquid cleaning, and determine the chemical liquid cleaning condition based on the prediction result.

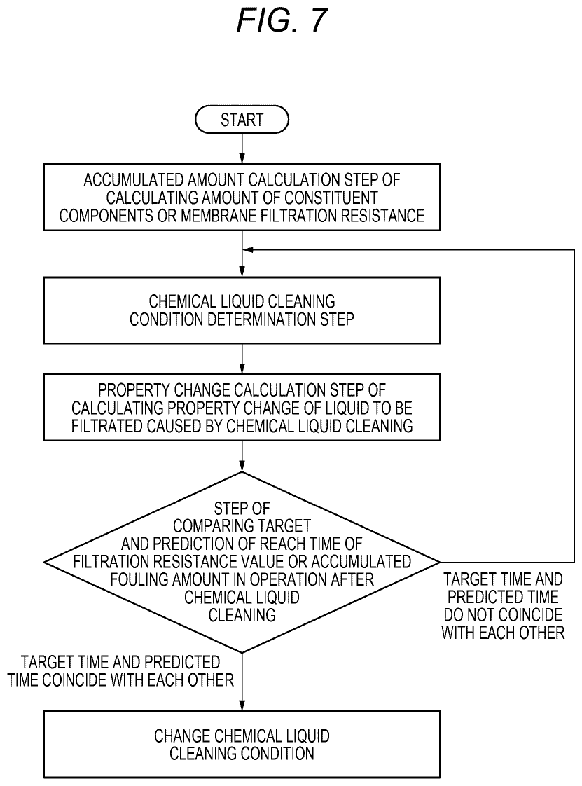

Next, a method for determining a chemical liquid cleaning condition and a physical cleaning condition according to the present disclosure will be described with reference to FIGS. 7 to 13.

FIG. 7 is a flowchart at the time of determining a chemical liquid cleaning condition according to a first embodiment. A value of the accumulated fouling amount or the membrane filtration resistance is predicted by the above calculation methods, the chemical liquid cleaning condition is determined, and the property change of the liquid-to-be-filtrated under the determined chemical liquid cleaning condition is calculated. Thereafter, the property change of the liquid-to-be-filtrated is reflected, and a time at which the value of the accumulated fouling amount or the membrane filtration resistance in an operation after the chemical liquid cleaning reaches a set value is predicted by the above calculation methods. When a reach time does not coincide with a target time, the chemical liquid cleaning condition is changed again in the chemical liquid cleaning condition determination step to determine the chemical liquid cleaning condition at which a predicted time coincides with the target time.

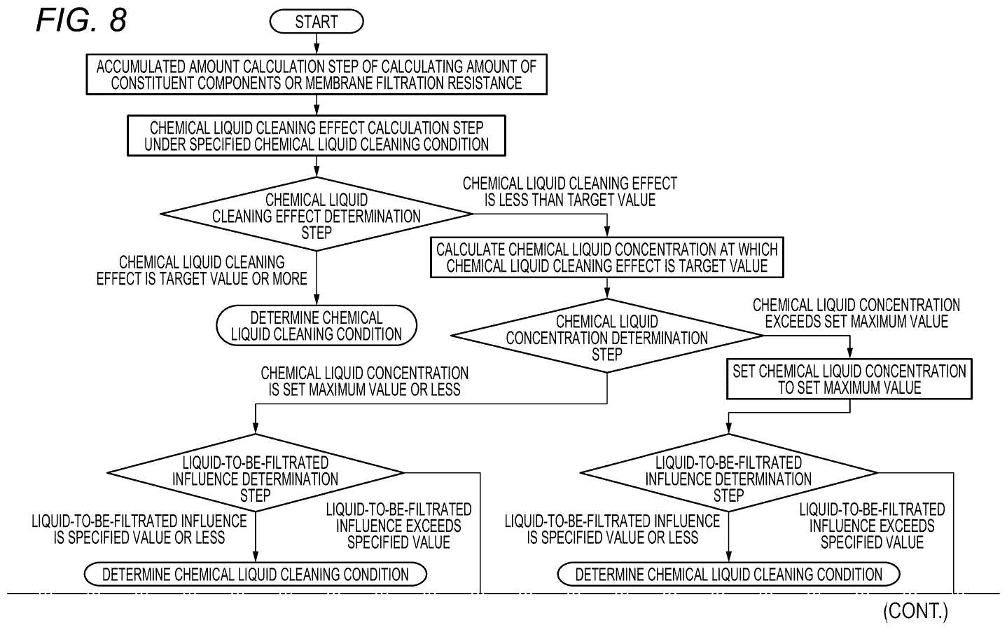

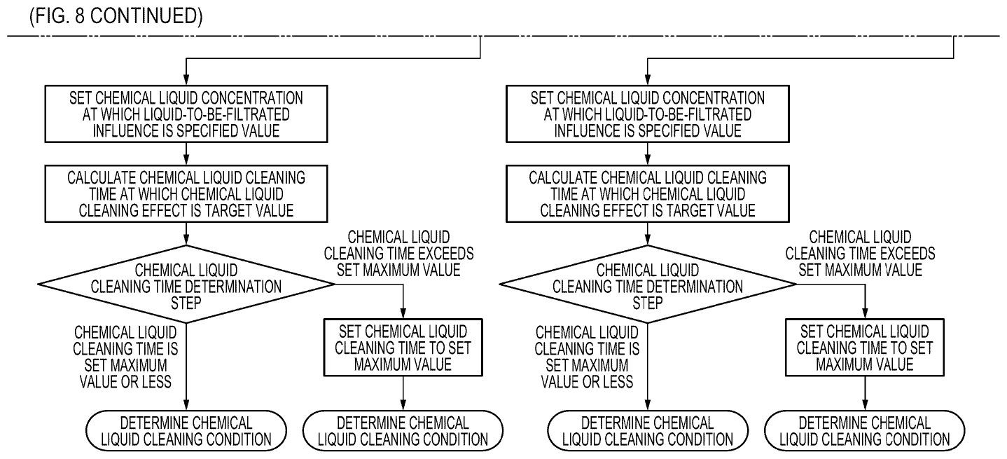

FIG. 8 is a flowchart at the time of determining a chemical liquid cleaning condition according to a second embodiment. The value of the accumulated fouling amount or the membrane filtration resistance is predicted by the above calculation method, and a chemical liquid cleaning effect according to a specified chemical liquid cleaning condition is calculated in the chemical liquid cleaning effect calculation step. Here, when the chemical liquid cleaning effect is a target value or more, the specified chemical liquid cleaning condition is determined. When the chemical liquid cleaning effect is less than the target value, the chemical liquid cleaning condition is changed. An order of determining the chemical liquid cleaning condition is not particularly limited, and it is preferable to first determine a chemical liquid concentration having a high contribution rate to the chemical liquid cleaning effect. Here, a case where a chemical liquid concentration is first determined will be described as an example. When the chemical liquid cleaning effect under the specified chemical liquid cleaning condition is less than the target value, a chemical liquid concentration at which the chemical liquid cleaning effect is the target value is calculated. When the calculated chemical liquid concentration is a set maximum value which is set in advance or less and the property change of the liquid-to-be-filtrated due to the chemical liquid cleaning at the determined chemical liquid concentration is a specified value or less, the chemical liquid cleaning condition at the determined chemical liquid concentration is determined. When the calculated chemical liquid concentration exceeds the set maximum value, or when the property change of the liquid-to-be-filtrated exceeds the specified value, a chemical liquid concentration in a range in which the above exceeding cases do not occur is determined, and next, a chemical liquid cleaning time at which a chemical liquid cleaning effect at the determined chemical liquid concentration is a target value is calculated. The calculated chemical liquid cleaning time is compared with a set maximum value which is set in advance, and the chemical liquid cleaning time is determined such that the chemical liquid cleaning time is the set maximum value or less.

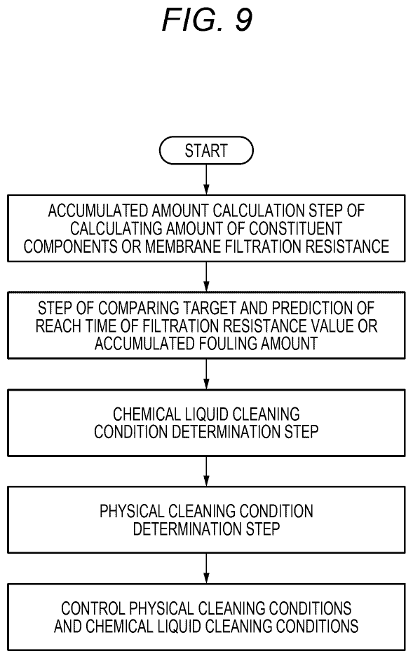

FIG. 9 is a flowchart at the time of determining a physical cleaning condition and a chemical liquid cleaning condition according to a third embodiment. A time at which the value of the accumulated fouling amount or the membrane filtration resistance reaches a set value is predicted by the above calculation methods, a cleaning condition is determined by a chemical liquid cleaning condition determination step and a physical cleaning condition determination step based on a predicted reach time and a target time, and operating condition control is performed. Although an order of determining cleaning conditions is not particularly limited, it is preferable to first determine the chemical liquid cleaning condition. In particular, in the membrane separation activated sludge method in which a power cost related to the physical cleaning condition is large in proportion to an operation cost of the separation membrane device, the chemical liquid cleaning condition is preferentially changed to eliminate adhesion of solid substances on the surface of the separation membrane or clogging, and then the physical cleaning condition is determined, thereby reducing the power cost related to the physical cleaning condition and effectively reducing the operation cost.

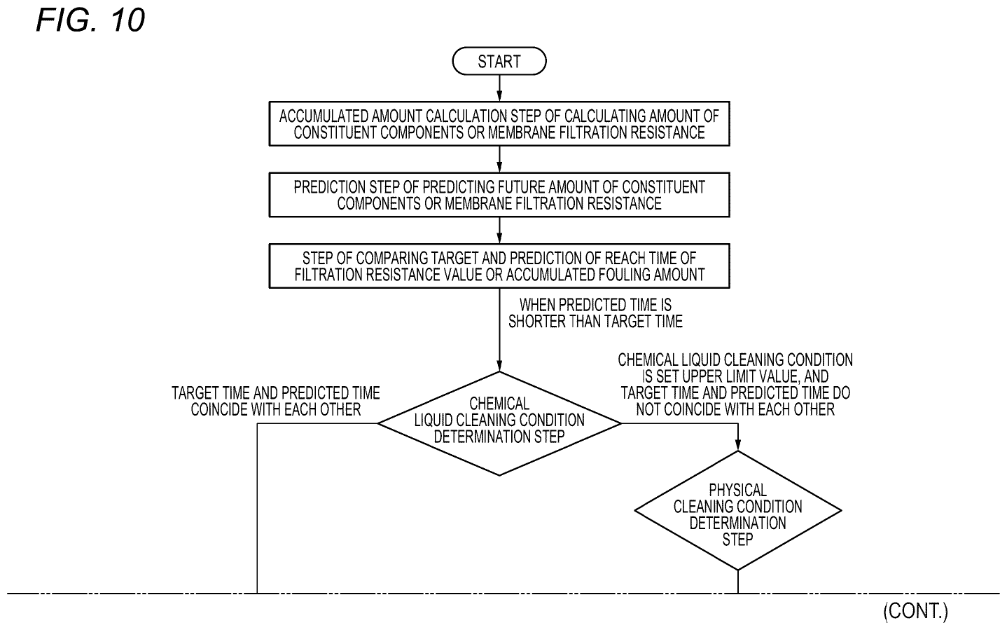

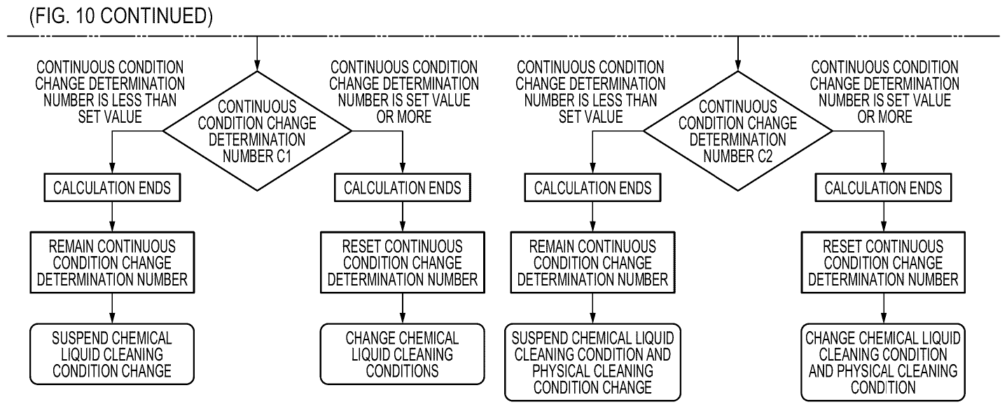

FIG. 10 is a flowchart for predicting a time at which the value of the accumulated fouling amount or the membrane filtration resistance reaches a set value by the above calculation method and determining a physical cleaning condition and a chemical liquid cleaning condition when a predicted reach time is shorter than a target time according to a fourth embodiment. It is preferable that a time at which the value of the accumulated fouling amount or the membrane filtration resistance reaches a set value is predicted by the above calculation methods, and when the reach time is shorter than the target time, the chemical liquid cleaning condition in which the predicted time coincides with the target time is first determined in the chemical liquid cleaning condition determination step. Here, when a continuous condition change determination number (C1) is a set value or more, a condition is changed to the determined chemical liquid cleaning condition, and when the continuous condition change determination number (C1) is less than the set value, a condition change to the determined chemical liquid cleaning condition is suspended. On the other hand, when the determined chemical liquid cleaning condition is a set upper limit value and the target time and the predicted time do not coincide with each other, a physical cleaning condition in which the predicted time coincides with the target time is determined secondly in the physical cleaning condition determination step. When the predicted reach time is shorter than the target time, an increase in the value of the accumulated fouling amount or the membrane filtration resistance is larger than prediction, and in order to remove accumulated fouling substances adhered on the membrane surface or in the membrane pores, a condition of increasing a cleaning intensity is required. Here, when a continuous condition change determination number (C2) is a set value or more, an operating condition is controlled to the determined chemical liquid cleaning condition and physical cleaning condition, and when the continuous condition change determination number (C2) is less than the set value, the control to the determined chemical liquid cleaning condition and physical cleaning condition is suspended.

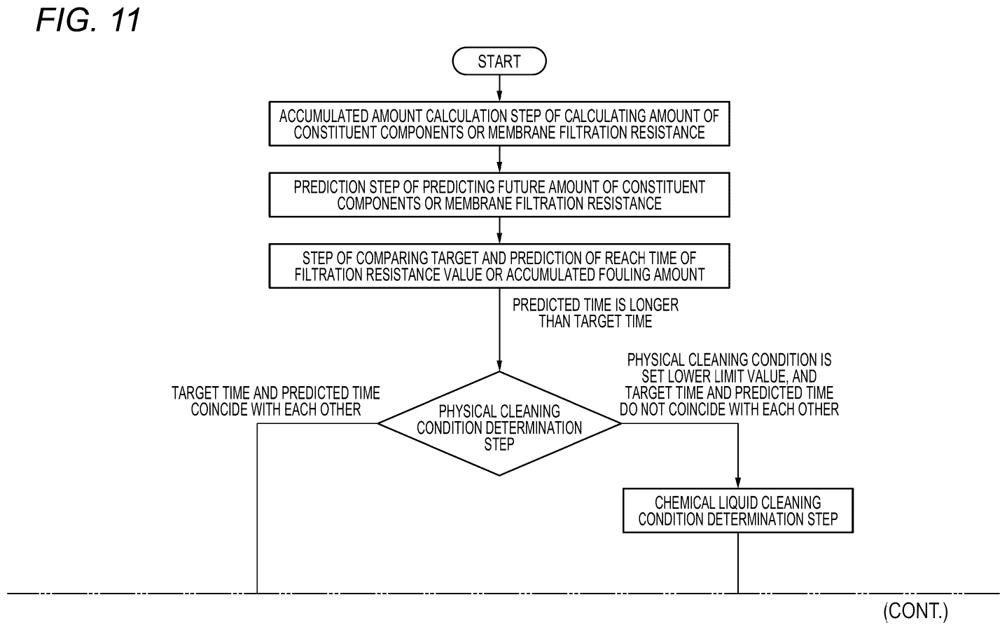

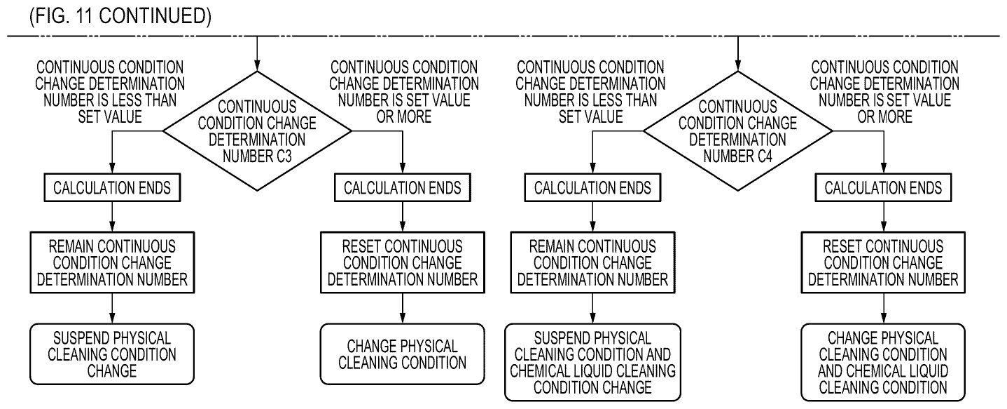

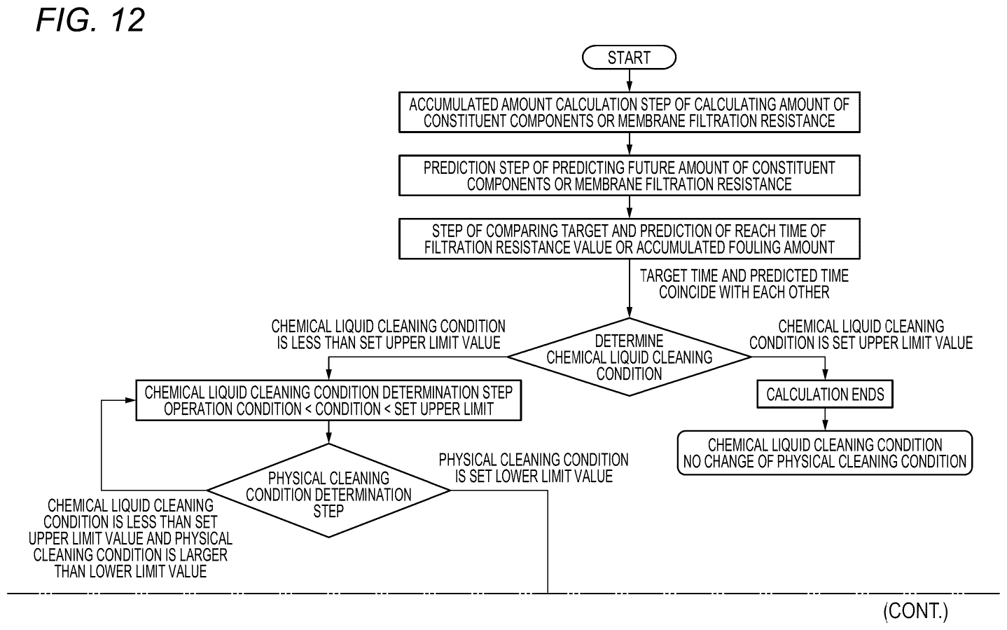

FIG. 11 is a flowchart for predicting a time at which the value of the accumulated fouling amount or the membrane filtration resistance reaches a set value by the above calculation methods and determining a physical cleaning condition and a chemical liquid cleaning condition when the predicted reach time is longer than the target time according to a fifth embodiment. It is preferable that a time at which the value of the accumulated fouling amount or the membrane filtration resistance reaches a set value is predicted by the above calculation methods, and when the reach time is longer than the target time, a physical cleaning condition in which the predicted time coincides with the target time is first determined in the physical cleaning condition determination step. When a continuous condition change determination number (C3) is a set value or more, an operating condition is controlled to the determined physical cleaning condition, and when the continuous condition change determination number (C3) is less than the set value, the control of the operating condition to the determined physical cleaning condition is suspended. On the other hand, when the determined physical cleaning condition is a set lower limit value and the target time and the predicted time do not coincide with each other, a chemical liquid cleaning condition in which the predicted time coincides with the target time is determined secondly in the chemical liquid cleaning condition determination step. When the predicted reach time is longer than the target time, an increase in the value of the accumulated fouling amount or the membrane filtration resistance is smaller than prediction, since a cleaning intensity can be reduced, a specified value here is a lower limit set value of the physical cleaning condition. Here, when a continuous condition change determination number (C4) is a set value or more, an operating condition is controlled to the determined chemical liquid cleaning condition and physical cleaning condition, and when the continuous condition change determination number (C4) is less than the set value, the control to the determined chemical liquid cleaning condition and physical cleaning condition is suspended.

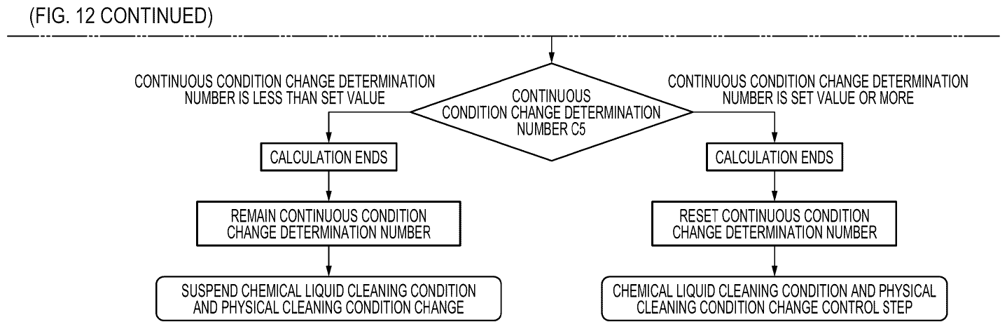

FIG. 12 is a flowchart for predicting a time at which the value of the accumulated fouling amount or the membrane filtration resistance reaches a set value by the above calculation methods and determining a physical cleaning condition and a chemical liquid cleaning condition when the predicted reach time coincides with the target time according to a sixth embodiment. A time at which the value of the accumulated fouling amount or the membrane filtration resistance reaches a set value is predicted by the above calculation methods, and when the predicted reach time coincides with the target time and a chemical liquid cleaning condition at the time of executing a cleaning condition determination flow is a set upper limit value, an operation is continued without performing a condition change for each cleaning condition. On the other hand, when the predicted reach time coincides with the target time and the chemical liquid cleaning condition is less than the set upper limit value, the chemical liquid cleaning condition determined in the chemical liquid cleaning condition determination step is determined to be larger than a chemical liquid cleaning condition at the time of executing the cleaning condition determination flow and less than the set upper limit value, and then a physical cleaning condition in which the predicted time coincides with the target time is determined. Here, when the physical cleaning condition is larger than the lower limit value, the chemical liquid cleaning condition is determined again by the chemical liquid cleaning condition determination step so that the physical cleaning condition has a lowest value, and then a physical cleaning condition in which the predicted time coincides with the target time is determined, so that a power cost can be reduced to a maximum extent. Here, when a continuous condition change determination number (C5) is a set value or more, an operating condition is controlled to the determined chemical liquid cleaning condition and physical cleaning condition, and when the continuous condition change determination number (C5) is less than the set value, the control to the determined chemical liquid cleaning condition and physical cleaning condition is suspended. Here, the continuous condition change determination numbers (C1 to C5) can be set freely. In a case where a cleaning intensity is increased due to a cleaning condition, it is preferable to set the number to be smaller than that in a case where the cleaning intensity is reduced, and quickly eliminate adhesion of solid substances on the surface of the separation membrane or clogging, and in a case where the cleaning intensity is reduced, it is preferable to make a determination with an assumed large number so as to confirm certainty of the situation. That is, when an increase in the value of the accumulated fouling amount or the membrane filtration resistance is larger than expected, or there is a concern that the value of the accumulated fouling amount or the membrane filtration resistance may increase rapidly, adhesion of solid substances on the surface of the separation membrane or clogging is preferentially eliminated rather than confirming certainty of the situation, and when the value of the accumulated fouling amount or the membrane filtration resistance is smaller than expected, certainty of the situation is preferentially confirmed rather than reducing a cleaning condition intensity, so that a state of the separation membrane can be well adjusted.

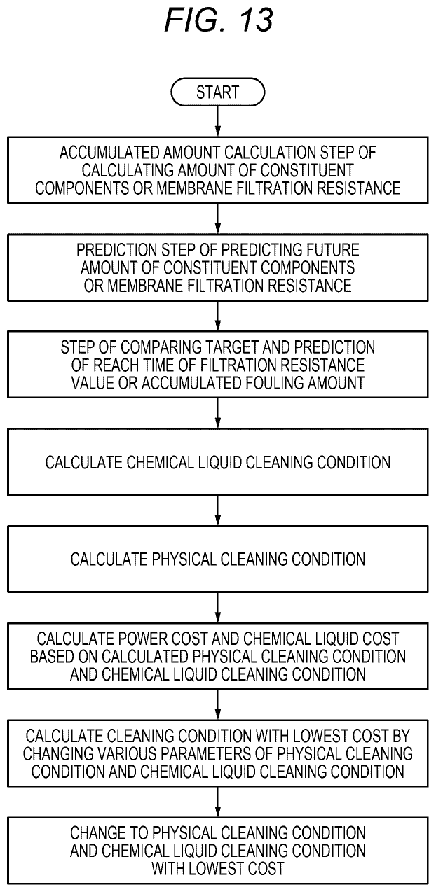

FIG. 13 is a flowchart for predicting a time at which the value of the accumulated fouling amount or the membrane filtration resistance reaches a set value by the above calculation methods and determining a chemical liquid cleaning condition and/or a physical cleaning condition based on an operation cost of the separation membrane device according to a seventh embodiment.

The time at which the value of the accumulated fouling amount or the membrane filtration resistance reaches the set value is predicted by the above calculation methods, the physical cleaning condition and/or the chemical liquid cleaning condition are determined such that the reach time is the target time, and the chemical liquid cleaning condition and/or the chemical liquid cleaning condition are controlled such that the operation cost is the lowest based on a prediction result of the value of the accumulated fouling amount or the membrane filtration resistance, the chemical liquid cleaning condition, and the like.

Here, the chemical liquid cleaning cost can be calculated by multiplying the number of times of chemical liquid cleaning in a reference period by a cost of one cleaning. The chemical liquid cleaning cost may be obtained by adding not only a cleaning liquid cost but also a power cost, a waste liquid treatment cost, a labor cost, and the like necessary for increasing a temperature.

The power cost can be calculated by multiplying, by electricity unit price, power calculated by discharge pressure of the pump 11 shown in FIG. 1 or the pump 1 shown in FIG. 2, an air volume of the air blower 7, and the like. In particular, in the membrane separation activated sludge method, since air is constantly supplied by an air blower, an aeration cost occupies most of the power cost.

A program for determining operating conditions according to the present disclosure is generally stored and installed in a computer-readable recording medium together with a control management system such as a PLC or a DCS that is generally installed in a membrane separation device, or operation data is extracted from the control management system via the Internet using a remote monitoring device and is stored and installed in a recording medium of an on-premise server or a cloud server installed in arbitrary place. In relation to the program for determining operating conditions according to the present disclosure, the program for determining operating conditions is preferably introduced to operate: for example, an initial value acquisition unit configured to acquire an initial value of an amount of the constituent components in the liquid-to-be-filtrated accumulated on the separation membrane; a data acquisition unit configured to acquire time-series change data of properties of the constituent components in the liquid-to-be-filtrated, time-series change data of the constituent components amount, and data indicating a time-series change in an operating condition of the separation membrane; a liquid-to-be-filtrated accumulated amount calculation unit configured to calculate membrane filtration resistance or an amount of the constituent components in the liquid-to-be-filtrated accumulated on a surface of the separation membrane and in pores of the separation membrane; a prediction unit configured to predict future membrane filtration resistance or amount of the constituent components in the liquid-to-be-filtrated accumulated in the separation membrane based on a calculation result of the accumulated amount; a comparison unit configured to compare the calculation result of the accumulated amount of the membrane filtration resistance or the amount of the constituent components in the liquid-to-be-filtrated accumulated in the separation membrane with a future prediction result; a chemical liquid cleaning effect calculation unit configured to calculate a restoration degree of an accumulated amount of the constituent components or the membrane filtration resistance in chemical liquid cleaning based on the calculation result of the accumulated amount; a chemical liquid cleaning condition determination unit configured to determine a chemical liquid cleaning condition based on the calculation result of the accumulated amount, the future prediction result of the membrane filtration resistance or the amount of the constituent components in the liquid-to-be-filtrated accumulated on the separation membrane, and a chemical liquid cleaning effect calculation result; a physical cleaning determination unit configured to determine a physical cleaning condition based on the calculation result of the accumulated amount, the future prediction result of the membrane filtration resistance or the amount of the constituent components, or the chemical liquid cleaning effect calculation result; a continuous condition change determination number recording unit configured to record a continuous condition change determination number; and an operation cost calculation unit configured to calculate a chemical liquid cost and a power cost based on a chemical liquid cleaning condition determination result and a physical cleaning condition determination result.

Description of symbols used in each formula is summarized in Table 2.

TABLE 2

| | Symbol | Unit | Description |
|---|---|---|---|
| * | a | [m/gC/Pa] | Cake resistance pressure dependency coefficient |
| * | b | [—] | Pore clogging cake dependency coefficient |
| | C | [mg/L] | Chemical liquid concentration |
| | Cₜ | [mg/L] | Chemical liquid concentration in membrane separation tank |
| * | Dₘₐₓ | [—] | Maximum consolidated degree (generally 1) |
| * | D(t) | [—] | Consolidated degree of cakes adhered on surface of separation membrane |
| | | | at time t |
| * | Dᵢ(t) | [—] | Consolidated degree of cakes in i-th layer adhered on surface of separation |
| | | | membrane |
| | d | [—] | Dependency coefficient of inorganic substance accumulated amount in |
| | | | chemical liquid cleaning |
| | e | [—] | Dependency coefficient of pore clogging amount in chemical liquid cleaning |
| | f | [—] | Dependency coefficient of cake amount in chemical liquid cleaning |
| | g | [—] | Dependency coefficient of flow rate in chemical liquid cleaning |
| | h | [—] | Dependency coefficient of temperature in chemical liquid cleaning |
| | i | [—] | Dependency coefficient of time in chemical liquid cleaning |
| | J(t) | [m/s] | Membrane filtration flux at time t |
| | j | | Dependency coefficient of concentration in chemical liquid cleaning |
| * | K_{f} | [gC^{2/3}/m^{4/3}] | Movement inhibition coefficient of sludge into pores of separation |
| | | | membrane |
| | Kₚ₁ | [—] | Liquid-to-be-filtered property initial influence coefficient |
| | Kₚ₂ | [—] | Liquid-to-be-filtered property influence coefficient |
| * | K_{T1} | [—] | Membrane cleaning inhibition coefficient |
| * | K_{T2} | [Pa] | Cake friction coefficient |
| * | k | [1/Paⁿ/s] | Unpeelable cake formation rate coefficient |
| * | k₁ | [1/(Pa/s)] | Consolidating rate coefficient |
| * | k₂ | [—] | Consolidating effect coefficient |
| | L | [gC/g/d] | Organic substance load amount |
| * | l | | Unpeelable cake pressure dependency coefficient |
| * | m | [—] | Pore clogging flux dependency coefficient |
| | n | [—] | Number of cake layers adhered on surface of separation membrane |
| | ΔP(t) | [Pa] | Transmembrane pressure difference at time t |
| | ΔP_{c}(t) | [Pa] | Pressure difference derived from cakes adhered on surface of separation |
| | | | membrane |
| | p | [—] | Liquid-to-be-filtered property and concentration dependency coefficient |
| | q | [—] | Liquid-to-be-filtered property and temperature dependency coefficient |
| | R(t) | [1/m] | Membrane filtration resistance at time t |
| | R_{c}(t) | [Pa] | Membrane filtration resistance derived from cakes adhered on surface of |
| | | | separation membrane |
| | R_{f}(t) | [1/m] | Membrane filtration resistance derived from pore clogging |
| | Rₘ | [1/m] | Membrane filtration resistance initial value |
| | r_{c} | [—] | Cake cleaning restoration ratio using sodium hypochlorite |
| | r_{f} | [—] | Pore clogging cleaning restoration ratio using sodium hypochlorite |
| | rₙ | [—] | Liquid-to-be-filtered property influence degree |
| | r_{p,0} | [—] | Initial value of liquid-to-be-filtered property influence degree |
| | s | | Liquid-to-be-filtered property and constituent component amount |
| | | | dependency coefficient |
| | T | [K] | Absolute temperature of liquid to be filtered |
| | T_{c} | [° C.] | Chemical liquid temperature |
| | Tₜ | [° C.] | Temperature in membrane separation tank |
| | t_{c} | [s] | Chemical liquid cleaning time |
| | t_{w} | [s] | Operation time after chemical liquid cleaning |
| | u | [—] | Temperature dependency coefficient of liquid-to-be-filtered property time |
| | | | change |
| | V | [L/m²] | Chemical liquid amount per unit membrane area |
| | v | [—] | Organic substance load dependency coefficient of liquid-to-be-filtered |
| | | | property time change |
| | X | [gC/m³] | SS of liquid to be filtered |
| | X_{c}(t) | [gC/m²] | Amount of cakes adhered on surface of separation membrane at time t |
| | X_{c,res}(t) | [gC/m²] | Amount of unpeelable cakes adhered on surface of separation membrane |
| | | | at time t |
| | X_{f}(t) | [gC/m²] | Amount of pore clogging at time t |
| | Xᵢ(t) | [gC/m²] | Inorganic substance fouling amount at time t |
| * | α | [m/gC] | Cake resistance coefficient |
| * | β | [m²/gC^{3/2}] | Pore clogging filtration resistance coefficient |
| * | Y | [1/m/s] | Cake peeling speed coefficient |
| * | ε | [m⁴/gC²] | Movement inhibition coefficient of sludge into pores of separation |
| | | | membrane |
| | η | [m³/gC] | Reciprocal of density of activated sludge |
| | θ | [—] | Pore clogging cleaning restoration coefficient |
| * | λ | [s^{m-1}.gC^{1-b}/m^{2+m-2b}] | Pore clogging speed coefficient |
| | μ | [Pa · s] | Membrane permeated liquid viscosity |
| | T(t) | [—] | Membrane cleaning power at time t |
| * | φ | [gC/m²/Pa/s] | Movement speed coefficient of sludge into pores of separation membrane |

* Membrane filterability parameter

### EXAMPLE

Hereinafter, the present disclosure will be specifically described with reference to examples, and the present disclosure is not limited to the examples.

### Example 1

A schematic structure of the separation membrane device used in the present example is shown in FIG. 1. The separation membrane device is a submerged membrane separation activated sludge device, and treats sewage. The sewage water which is raw water was intermittently fed into the liquid-to-be-filtrated tank 3 having an effective capacity of 30.0 L at an average flow rate of 90.0 L/d. Activated sludge was stored in the liquid-to-be-filtrated tank 3 as a liquid-to-be-filtrated, the submerged membrane separation unit 2 was immersed in the liquid-to-be-filtrated, an diffuser pipe 4 was installed in a lower portion of the liquid-to-be-filtrated tank 3, and air was supplied to the air diffuser pipe 4 from the air blower 7 serving as a cleaning unit. That is, in the device, air bubbles supplied from the diffuser pipe 4 come into contact with the membrane surface, and a flow of the activated sludge caused by aeration is generated at the same time, so that an effect of peeling adhered substances on the membrane surface from the membrane can be obtained. Here, a flat microfiltration membrane unit (an effective membrane area: 0.17 m²) made of polyvinylidene difluoride (PVDF) was used as the submerged membrane separation unit, and the suction pump 11 installed on a membrane permeate side was used as a membrane filtrate acquisition unit.

In the present example, the configuration (a3) was adopted for the calculation step. Here, the formula (5) was used in the calculation step 1a, the formula (9) was used in the calculation step 1b, the formula (11) was used in the calculation step 1c, the formulas (12) to (14) were used in the calculation step 2, the formula (1) was used in the calculation step 3 (here, the formula (2) was used for u), and a calculation was performed by using a program incorporated with the calculation steps and the calculation formulas.

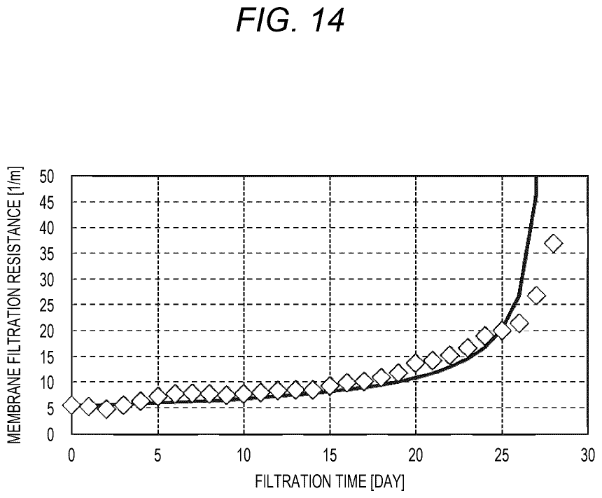

The membrane filtration resistance initial value Rm=3.5×10¹⁰ was obtained by performing a membrane filtration test using pure water as the membrane filtration resistance initial value, and using an average value of a relationship between a total filtrate amount and membrane filtration resistance per unit membrane area created based on results. As initial values, the cake amount Xc adhered on the surface of the separation membrane was set to 0, the unpeelable cake amount Xc,res adhered on the surface of the separation membrane was set to 0, and the pore clogging amount Xf was set to 0. The membrane cleaning power value t was set to 1.0, the reciprocal n of a density of the constituent components in the liquid-to-be-filtrated was set to 1.0×10⁻⁶, and SS of the liquid-to-be-filtrated X was set to 6.84×10³ based on a measured value. A measured value measured by a temperature sensor was used as the temperature T of the liquid-to-be-filtrated, and a value obtained by dividing a measured value of a filtration flow rate measured by a flow rate sensor by a membrane area was used as the membrane filtration flux J (a set value was 6.94×10⁻⁶ m³/m²/s). Values calculated from a previous experience formula based on image information obtained by imaging activated sludge 10 times a day using an optical microscope or the like and a camera and processing the imaged images were used as membrane filterability parameters necessary for the membrane filtration program. FIG. 14 shows membrane filtration prediction results and measurement results using the present program. As shown in FIG. 14, the membrane filtration prediction results are very similar to measurement results, and membrane filtration prediction can be achieved with high accuracy.

At a time t1, the cake amount Xc adhered on the surface of the separation membrane was calculated to be 24.3 and the pore clogging amount Xf was calculated to be 0.1 using the program. Here, a chemical liquid cleaning restoration degree when the chemical liquid cleaning was performed at the time t1 was calculated by using the formulas (22) and (23). Chemical liquid cleaning conditions were an immersion time tc=2, a chemical liquid temperature Tc=25, a chemical liquid amount V per unit membrane area=1.0, and an inorganic substance accumulated amount Xi per unit membrane area=1.5. j, i, h, g, e, d, and θ were set in advance such that a difference between a previous test result and a calculation result was the smallest. The cake amount Xc adhered on the surface of the separation membrane after the chemical liquid cleaning was set to 10.0 as a target value, and as a result of calculating a sodium hypochlorite concentration for restoring to a target value after the chemical liquid cleaning, the sodium hypochlorite concentration C was calculated to be 3000. At the time t1, the chemical liquid cleaning was performed under the chemical liquid conditions and with the sodium hypochlorite concentration C being 3000, the separation membrane was taken out from the separation membrane device and inspected, and as a result of a measurement, the cake amount Xc adhered on the surface of the separation membrane after the chemical liquid cleaning was 9.8, and it was confirmed that a calculation result of the chemical liquid cleaning restoration degree can reproduce a measured value.

### Example 2

The chemical liquid cleaning conditions in the separation membrane device described in Example 1 were determined.

At a time t2, the cake amount Xc adhered on the surface of the separation membrane was calculated to be 74.6 and the pore clogging amount Xf was calculated to be 0.2 using the program.

Here, a chemical liquid cleaning restoration degree when chemical liquid cleaning was performed at the time t2 was calculated by using the formulas (22) and (23). Chemical liquid cleaning conditions were an immersion time tc=2, a chemical liquid temperature Tc=25, a chemical liquid amount V per unit membrane area=1.0, and an inorganic substance accumulated amount Xi per unit membrane area=2.2. j, i, h, g, e, d, and θ were set in advance such that a difference between a previous test result and a calculation result was the smallest. The cake amount Xc adhered on the surface of the separation membrane after the chemical liquid cleaning was set to 10.0 as a target value, and as a result of calculating a sodium hypochlorite concentration for restoring to a target value after the chemical liquid cleaning, the sodium hypochlorite concentration C was calculated to be 6000. At the time t2, the chemical liquid cleaning was performed under the chemical liquid conditions and with the sodium hypochlorite concentration C being 6000, the separation membrane was taken out from the separation membrane device and inspected, and as a result of a measurement, the cake amount Xc adhered on the surface of the separation membrane after the chemical liquid cleaning was 8.9, and it was confirmed that a calculation result of the chemical liquid cleaning restoration degree can reproduce a measured value.

### Example 3

The chemical liquid cleaning conditions in the separation membrane device described in Example 1 were determined.

At a time t3, the cake amount Xc adhered on the surface of the separation membrane was calculated to be 21.4, the pore clogging amount Xf was calculated to be 0.6, and the membrane filtration resistance R was calculated to be 52.9 using the program.

Here, a chemical liquid cleaning restoration degree when the chemical liquid cleaning was performed at the time t3 was calculated by using the formulas (22) and (23). Chemical liquid cleaning conditions were an immersion time tc=2, a chemical liquid temperature Tc=25, a chemical liquid amount V per unit membrane area=1.0, and an inorganic substance accumulated amount Xi per unit membrane area=5.1. j, i, h, g, e, d, and θ were set in advance such that a difference between a previous test result and a calculation result was the smallest. The membrane resistance R after the chemical liquid cleaning was set to 15 as a target value, and a sodium hypochlorite concentration for restoring to a target value after the chemical liquid cleaning was calculated, but there is no solution. Subsequently, the sodium hypochlorite concentration C was set to 3000, and then a chemical liquid cleaning restoration degree when acid cleaning using citric acid was performed was calculated by using the formulas (22) and (23) in a similar manner. Chemical liquid cleaning conditions with the citric acid were an immersion time tc=2, a chemical liquid temperature Tc=25, a chemical liquid amount V per unit membrane area=1.0, and an inorganic substance accumulated amount Xi per unit membrane area=5.1. Values different from those used in the chemical liquid cleaning using the citric acid based on a previous test result were used as j, i, h, g, e, d, and θ. The membrane resistance R after the chemical liquid cleaning was set to 15 as a target value, and as a result of calculating a citric acid concentration for restoring to a target value after the chemical liquid cleaning, the citric acid concentration C was calculated to be 2000.

At the time t3, after the chemical liquid cleaning was performed under the chemical liquid conditions and with the sodium hypochlorite concentration C being 3000, the chemical liquid cleaning was performed again with the citric acid concentration C being 2000, the separation membrane was taken out from the separation membrane device and inspected, and as a result of a measurement, the membrane filtration resistance R after the chemical liquid cleaning was 14.5, and it was confirmed that a calculation result of the chemical liquid cleaning restoration degree can reproduce a measured value.

Although various embodiments have been described above with reference to the drawings, it is needless to say that the present disclosure is not limited to those examples. It is apparent to those skilled in the art that various variations or modifications can be conceived within the scope described in the claims, and it should be naturally understood that those belong to the technical scope of the present disclosure. In addition, the components described in the above embodiments may be combined optionally without departing from the gist of the invention.

The present application is based on the Japanese patent application (JP2021-212050A) filed on Dec. 27, 2021, and the contents of which are incorporated herein by reference.

### REFERENCE SIGNS LIST

1: liquid-to-be-filtrated supply pump
2: submerged membrane separation unit
3: liquid-to-be-filtrated tank
4: diffuser pipe
5: filtrate storage tank
6: chemical liquid storage tank
7: air blower
8: liquid-to-be-filtrated flow meter
9: filtrate flow meter
10: air flow meter
11: suction pump
12: separation membrane module
13: chemical liquid supply pump
14: reverse liquid cleaning pump
15: liquid discharge line
16: pore clogging
17: peelable cake
18: unpeelable cake
19: separation membrane

1. A method for operating a separation membrane in which a liquid-to-be-filtrated is subjected to filtration to obtain a filtrate, the method comprising:
an accumulated amount calculation step of, based on an initial value of an amount of constituent components of a liquid-to-be-filtrated accumulated in a separation membrane, and
a change over time in the constituent components of the liquid-to-be-filtrated, a change over time in the amount of the constituent components, and a change over time in an operating condition of the separation membrane after setting the initial value,
calculating the amount of the constituent components of the liquid-to-be-filtrated accumulated on a surface and in pores of the separation membrane after setting the initial value;
a chemical liquid cleaning effect calculation step of calculating a restoration degree of an accumulated amount of the constituent components or membrane filtration resistance in chemical liquid cleaning based on a result of accumulated amount calculation; and
a chemical liquid cleaning condition determination step of determining a chemical liquid cleaning condition based on results obtained in the accumulated amount calculation step and the chemical liquid cleaning effect calculation step.

2. The method for operating a separation membrane according to claim 1, wherein the separation membrane is a microfiltration membrane or an ultrafiltration membrane.

3. The method for operating a separation membrane according to claim 1, wherein the liquid-to-be-filtrated is an activated sludge or a microorganism culture solution.

4. The method for operating a separation membrane according to claim 1, wherein the method for operating a separation membrane is an operation method of cleaning the surface of the separation membrane simultaneously or intermittently with filtration.

5. The method for operating a separation membrane according to claim 1, wherein the membrane filtration resistance or the amount of the constituent components of the liquid-to-be-filtrated accumulated on the surface of the separation membrane, which is calculated in the accumulated amount calculation step, is divided into a plurality of pieces of membrane filtration resistance or amounts of the constituent components of the liquid-to-be-filtrated based on a physical cleaning condition for peeling or a degree of consolidation.

6. The method for operating a separation membrane according to claim 1, wherein the method for operating a separation membrane is an operation method for continuing membrane filtration while controlling a membrane filtration flow rate (flux) to a set value, and in the accumulated amount calculation step, the membrane filtration resistance or the amount of the constituent components of the liquid-to-be-filtrated accumulated on the surface or in the pores of the separation membrane is calculated by performing a calculation step 1a, at least any one of a calculation step 1b and a calculation step 1c, and a calculation step 2 and/or a calculation step 3 in the followings, and repeatedly performing the calculation steps while updating time to calculate the amount of the constituent components of the liquid-to-be-filtrated adhered to the separation membrane:
the (calculation step 1a) of calculating an amount value of the constituent components of the liquid-to-be-filtrated adhered on the surface of the separation membrane at a time t+Δt (here, tis any number of 0 or more, and Δt is any positive number) based on an amount value of the constituent components of the liquid-to-be-filtrated and a membrane filtration flow rate (flux) value or a transmembrane pressure difference value at a time t;
the (calculation step 1b) of calculating an amount value of the constituent components of the liquid-to-be-filtrated present in the pores of the separation membrane at the time t+Δt based on the transmembrane pressure difference value and/or the membrane filtration flow rate (flux) value at the time t;
the (calculation step 1c) of calculating an amount value of the constituent components of the liquid-to-be-filtrated consolidated and adhered on the surface of the separation membrane at the time t+Δt based on the transmembrane pressure difference value at the time t;
the (calculation step 2) of calculating a membrane filtration resistance value at the time t+Δt based on the amount value of the constituent components of the liquid-to-be-filtrated adhered on the surface of the separation membrane, which is calculated in the calculation step 1a, and the amount value of the constituent components of the liquid-to-be-filtrated present in the pores of the separation membrane, which is calculated in the calculation step 1b, and/or the amount value of the constituent components of the liquid-to-be-filtrated consolidated and adhered on the surface of the separation membrane, which is calculated in the calculation step 1c; and
the (calculation step 3) of calculating a transmembrane pressure difference value at the time t+Δt based on the amount value of the constituent components of the liquid-to-be-filtrated adhered on the surface of the separation membrane, which is calculated in the calculation step 1a, and the amount value of the constituent components of the liquid-to-be-filtrated present in the pores of the separation membrane, which is calculated in the calculation step 1b, and/or the amount value of the constituent components of the liquid-to-be-filtrated consolidated and adhered on the surface of the separation membrane, which is calculated in the calculation step 1c, or based on the membrane filtration resistance value which is calculated in the calculation step 2.

7. The method for operating a separation membrane according to claim 1, wherein the method for operating a separation membrane is an operation method for continuing membrane filtration while controlling a transmembrane pressure difference to a set value, and in the accumulated amount calculation step, the membrane filtration resistance or the amount of the constituent components of the liquid-to-be-filtrated accumulated on the surface or in the pores of the separation membrane is calculated by performing a calculation step 1a, at least any one of a calculation step 1b and a calculation step 1c, and a calculation step 2 and/or a calculation step 4 in the followings, and repeatedly performing the calculation steps while updating time to calculate the amount of the constituent components of the liquid-to-be-filtrated adhered to the separation membrane:
the (calculation step 1a) of calculating an amount value of the constituent components of the liquid-to-be-filtrated adhered on the surface of the separation membrane at a time t+Δt (here, tis any number of 0 or more, and Δt is any positive number) based on an amount value of the constituent components of the liquid-to-be-filtrated and a membrane filtration flow rate (flux) value or a transmembrane pressure difference value at a time t;
the (calculation step 1b) of calculating an amount value of the constituent components of the liquid-to-be-filtrated present in the pores of the separation membrane at the time t+Δt based on the transmembrane pressure difference value and/or the membrane filtration flow rate (flux) value at the time t;
the (calculation step 1c) of calculating an amount value of the constituent components of the liquid-to-be-filtrated consolidated and adhered on the surface of the separation membrane at the time t+Δt based on the transmembrane pressure difference value at the time t;
the (calculation step 2) of calculating a membrane filtration resistance value at the time t+Δt based on the amount value of the constituent components of the liquid-to-be-filtrated adhered on the surface of the separation membrane, which is calculated in the calculation step 1a, and the amount value of the constituent components of the liquid-to-be-filtrated present in the pores of the separation membrane, which is calculated in the calculation step 1b, and/or the amount value of the constituent components of the liquid-to-be-filtrated consolidated and adhered on the surface of the separation membrane, which is calculated in the calculation step 1c; and
the (calculation step 4) of calculating a membrane filtration flow rate (flux) value at the time t+Δt based on the amount value of the constituent components of the liquid-to-be-filtrated adhered on the surface of the separation membrane, which is calculated in the calculation step 1a, and the amount value of the constituent components of the liquid-to-be-filtrated present in the pores of the separation membrane, which is calculated in the calculation step 1b, and/or the amount value of the constituent components of the liquid-to-be-filtrated consolidated and adhered on the surface of the separation membrane, which is calculated in the calculation step 1c, or based on the membrane filtration resistance value which is calculated in the calculation step 2.

8. The method for operating a separation membrane according to claim 1, wherein in the accumulated amount calculation step, an amount of inorganic constituent components of the liquid-to-be-filtrated accumulated on the surface and in the pores of the separation membrane is calculated.

9. The method for operating a separation membrane according to claim 1, wherein the chemical liquid cleaning condition determined in the chemical liquid cleaning condition determination step is at least any of a chemical liquid concentration, a chemical liquid cleaning time, a chemical liquid temperature, a chemical liquid amount, a chemical liquid supply flow rate, a number of times of chemical liquid cleaning, a chemical liquid type, and a chemical liquid cleaning interval in the chemical liquid cleaning.

10. The method for operating a separation membrane according to claim 1, wherein the chemical liquid type is changed when a calculation result of the restoration degree of the accumulated amount of the constituent components or the membrane filtration resistance of the chemical liquid cleaning is a specified value or less.

11. The method for operating a separation membrane according to claim 1, wherein in the chemical liquid cleaning condition determination step, the chemical liquid concentration or the chemical liquid type is changed when a calculation result of the amount of the constituent components of the liquid-to-be-filtrated accumulated on the surface of the separation membrane or a calculation result of the amount of the constituent components of the liquid-to-be-filtrated accumulated in the pores of the separation membrane is a specified value or more.

12. The method for operating a separation membrane according to claim 11, wherein in the chemical liquid cleaning condition determination step, the chemical liquid concentration in the chemical liquid cleaning is increased when the calculation result of the amount of the constituent components of the liquid-to-be-filtrated accumulated on the surface of the separation membrane is the specified value or more, and at least an organic acid is selected as the chemical liquid type in the chemical liquid cleaning when the calculation result of the amount of the constituent components of the liquid-to-be-filtrated accumulated in the pores of the separation membrane is the specified value or more.

13. The method for operating a separation membrane according to claim 1, wherein the chemical liquid cleaning is performed when a calculated value of the accumulated amount or the membrane filtration resistance of the liquid-to-be-filtrated, which is calculated in the accumulated amount calculation step, or a change rate over time of the calculated value reaches a specified value.

14. The method for operating a separation membrane according to claim 1, wherein in the chemical liquid cleaning condition determination step, the chemical liquid cleaning condition is determined in consideration of an influence on filterability of the liquid-to-be-filtrated.

15. The method for operating a separation membrane according to claim 1, wherein
an operation includes a filtrating operation, a physical cleaning operation performed during the filtrating operation or in a state where the filtrating operation is stopped, and a chemical liquid cleaning operation performed in a state where the filtrating operation is stopped, the method further comprises:
a physical cleaning condition determination step of determining a physical cleaning condition based on the calculation result of the accumulated amount and a result of the chemical liquid cleaning effect calculation step; and
an operating condition control step of controlling the operating condition of the separation membrane based on a condition determined in the chemical liquid cleaning condition determination step and a condition determined in the physical cleaning condition determination step.

16. The method for operating a separation membrane according to claim 15, the method further comprising:
a prediction step of predicting a time at which a value of the accumulated amount or the membrane filtration resistance reaches a set value based on the calculation result of the accumulated amount of the liquid-to-be-filtrated, wherein
the chemical liquid cleaning condition determined in the chemical liquid cleaning condition determination step and/or the physical cleaning condition determined in the physical cleaning condition determination step are changed based on a calculation result of the prediction step so that a reach time is a target time.

17. The method for operating a separation membrane according to claim 16, wherein the chemical liquid cleaning condition is determined by the chemical liquid cleaning condition determination step based on the calculation result of the prediction step so that the chemical liquid cleaning condition is within a specified value, and
next, a time at which a value of the accumulated amount or the membrane filtration resistance reaches a set value is predicted by the accumulated amount calculation step of the liquid-to-be-filtrated and the chemical liquid cleaning effect calculation step based on a condition after the chemical liquid cleaning condition is changed, and the operating condition is changed to the physical cleaning condition determined in the physical cleaning condition determination step so that the reach time is the target time.

18. The method for operating a separation membrane according to claim 16, wherein
in a case where an increase in a predicted value of the accumulated amount or the membrane filtration resistance is large and the reach time is shorter than the target time in the calculation result of the prediction step,
the chemical liquid cleaning condition is determined in the chemical liquid cleaning condition determination step so that the reach time is the target time, and when the chemical liquid cleaning condition determined in the chemical liquid cleaning condition determination step is a set upper limit value and the reach time does not coincide with the target time,
next, the time at which the value of the accumulated amount or the membrane filtration resistance reaches the set value is predicted by the accumulated amount calculation step of the liquid-to-be-filtrated and the chemical liquid cleaning effect calculation step based on the condition after the chemical liquid cleaning condition is changed, and the operating condition is changed to the physical cleaning condition determined in the physical cleaning condition determination step so that the reach time is the target time.

19. The method for operating a separation membrane according to claim 16, wherein
in a case where an increase in a predicted value of the accumulated amount or the membrane filtration resistance is large and the reach time is longer than the target time in the calculation result of the prediction step,
the physical cleaning condition is determined in the physical cleaning condition determination step so that the reach time is the target time, and when the physical cleaning condition determined in the physical cleaning condition determination step is a set lower limit value and the reach time does not coincide with the target time,
next, the time at which the value of the accumulated amount or the membrane filtration resistance reaches the set value is predicted by the accumulated amount calculation step of the liquid-to-be-filtrated and the chemical liquid cleaning effect calculation step based on the condition after the physical cleaning condition is changed, and the operating condition is changed to the chemical liquid cleaning condition determined in the chemical liquid cleaning condition determination step so that the reach time is the target time.

20. The method for operating a separation membrane according to claim 15, wherein
a chemical liquid cleaning cost calculation unit configured to calculate a chemical liquid cleaning cost related to the chemical liquid cleaning of the separation membrane based on the chemical liquid cleaning condition determined in the chemical liquid cleaning condition determination step, a power cost calculation unit configured to calculate a power cost related to an operation of the separation membrane based on the physical cleaning condition determined in the physical cleaning condition determination step, and an operation cost calculation unit configured to calculate an operation cost related to an operation of the separation membrane based on the chemical cost calculation unit and the power cost calculation unit are provided, and
the method further comprises: an optimum operating condition determination step of selecting, based on the operation cost calculated by the operation cost calculation unit, an operating condition enabling cleaning with a low cost from operating conditions of the separation membrane determined in the operating condition determination step.

21. The method for operating a separation membrane according to claim 15, wherein the physical cleaning condition determined in the physical cleaning condition determination step is at least any of an air flow rate, a reverse liquid cleaning flow rate, and a cleaning time.

22. A separation membrane device for filtrating a water-to-be-filtrated to obtain a filtrate, the separation membrane device comprising:
an initial value acquisition unit configured to acquire an initial value of an amount of constituent components of a liquid-to-be-filtrated accumulated in a separation membrane;
a data acquisition unit configured to acquire time-series change data of properties of the constituent components of the liquid-to-be-filtrated, time-series change data of the amount of the constituent components, and data indicating a time-series change in an operating condition of the separation membrane;
a calculation unit configured to calculate an amount of the constituent components of the liquid-to-be-filtrated accumulated on a surface and in pores of the separation membrane after the initial value is set;
a unit configured to calculate a restoration degree of an accumulated amount of the constituent components or membrane filtration resistance in chemical liquid cleaning based on a calculation result of the accumulated amount; and
a chemical liquid cleaning condition determination unit configured to determine a chemical liquid cleaning condition based on a result obtained by the calculation unit, wherein the chemical liquid cleaning is automatically performed based on the chemical liquid cleaning condition determined by the chemical liquid cleaning condition determination unit.

23. A non-transitory computer-readable recording medium storing aA program for determining operating conditions of a separation membrane so as to determine a chemical liquid cleaning condition for the separation membrane to filtrate a water-to-be-filtrated to obtain a filtrate, the program causing a computer to execute:
a step of acquiring an initial value of an amount of constituent components in a liquid-to-be-filtrated accumulated in the separation membrane;
a step of acquiring data indicating a time-series change in properties of the constituent components in the liquid-to-be-filtrated and an amount of the constituent components and data indicating a time-series change in an operating condition of the separation membrane after the initial value is set;
a step of integrating and calculating an amount of the constituent components in the liquid-to-be-filtrated accumulated on a surface and in pores of the separation membrane after the initial value is set,
a step of calculating a restoration degree of an accumulated amount of the constituent components or membrane filtration resistance in chemical liquid cleaning based on a calculation result of the accumulated amount, and
a step of determining the chemical liquid cleaning condition based on the calculation result.

24. (canceled)
